(19) United States
(12) Patent Application Publication
(10) Pub. No.: US 2003/0140063 A1
(43) Pub. Date: Jul. 24, 2003

(54) System and method for providing health care advice by diagnosing system function

(76) Inventors: Joseph E. Pizzorno, Seattle, WA (US); Arnold K. Evans, Kent, WA (US); Buck Levin, Vashon Island, WA (US)

Correspondence Address: GARY CARY WARE & FREIDENRICH LLP, 1755 EMBARCADERO ROAD, PALO ALTO, CA, 94303-3340, US

(21) Appl. No.: 10/322,282

(22) Filed: Dec. 17, 2002

Related U.S. Application Data
(60) Provisional application No. 60/341,649, filed on Dec. 17, 2001.

(51) Int. Cl. G06F 7/00

(52) U.S. Cl. 707/104.1

(57) ABSTRACT

A personalized health care advice system and method are provided wherein the system incorporates an expert system for generated smart questions which are used to determine the appropriate course of action and disease diagnosis. In a preferred embodiment, the system uses probabilistic analysis to determine a diagnosis.

### RELATED APPLICATION

This application claims priority under 35 USC §119 from U.S. Provisional Application No. 60/341,649 filed on Dec. 17, 2001 and entitled “System and Method for Providing Health Advice by Diagnosing System Function,” which is incorporated herein by reference in its entirety.

### FIELD OF THE INVENTION

This invention relates generally to a system and method for generating personalized health care advice and in particular to a computer implemented system and method for generating personalized health care advice using an expert system.

### BACKGROUND OF THE INVENTION

Typically, a person may go to a health care provider, such as a doctor, who may be able to diagnose a disease based on one or more different indications/factors which may indicate the disease. There are also computer based systems which attempt to determine a particular type of vitamin formula for a particular user. One such system is a system developed by Custom Nutrition Services in Carlsbad, Calif. The system recommends personalized vitamin formulas based on diseases present in a user. The method that they use to recommend the vitamin formula is very primitive in which a few common diseases are matched to a few common dietary supplements. This system does no assessment of health or body function although it does ask a series of questions. However, the questions are not personalized to a particular user, nor do they provide an assessment of the user's unique physiology or modify the recommendations based of the user's unique physiology.

Various literature has shown that a potentially large number of dietary, nutrient and lifestyle needs of a user may affect the health of the user. For example, careful review of the research literature yielded over 15 scientifically validated nutrients, all of which may be critically important for a person with arteriosclerosis. The same kind of critical nutrient needs have been shown for virtually every chronic disease prevalent in our society. The challenge, however, is to determine which of these nutrients is specifically needed by each biochemically-unique individual It is impossible for a practitioner to know all the biochemical pathways, recognize which symptoms and diseases are associated with dysfunction of which biochemical pathways, and then to make mathematically-accurate inferences and decisions. Equally important is recognizing which nutrients may be inappropriate, as well as which lifestyle, environmental toxin exposure and genetic tendencies may be playing a role in a person's health problem.

Most available dietary supplements simply supply several of the most commonly needed nutrients to provide “structure and function” support. Unfortunately, this “shotgun” approach is rarely able to safely and economically provide the dosage levels actually needed to significantly improve the condition and is very likely to not even contain the specific nutrients that are most needed by the individual. On the other hand, trying to ask a user every question necessary to determine the presence of every possible deficiency would be prohibitively burdensome.

It is desirable therefore, to provide a system and method for providing health care advice in which the physiological needs of each individual user may be determined.

### SUMMARY OF THE INVENTION

In accordance with the invention, a system and method for personalized health care advice are provided which generate an understanding of the unique physiology of a person based on a series of smart questions. In more detail, the solution is to use artificial intelligence to guide the determination of the individual's most important physiological needs. This is accomplished by using rigorous probabilistic reasoning based on sound research-based physiological understanding. In more detail, the system asks a limited number of leading questions, the answers to which provide probabilistic ranking to progressively more relevant and differentiating questions. These are known as the smart questions. Thus, for each user, a unique and personalized set of questions are posed based on the probabilistic reasoning so that a user does not have to go through a myriad of irrelevant questions which do not apply to the user (or his condition) while asking the key questions for the user which will accurately provide the system with an understanding of each user so that the system can provide focused lifestyle, dietary, nutritional supplement and herbal interventions and advice that are individual to each user of the system. In terms of the expert system, only questions from nodes being probabilistically triggered are posed to the user wherein the probabilities are based on the information that the user has provided. In accordance with the invention, each record in the database is a node or probabilistic link between nodes for the expert system.

In accordance with the invention, the system provides a unique way of providing health care advice by diagnosing system function, rather than the presence of disease. In a preferred embodiment of the invention, the system determines probabilistically, using Boolean and Bayesian logic, which systems of the user are dysfunctional, the cause(s) of the dysfunction and which interventions (both self-care and professionally-supplied) are most likely to restore normal function.

The recommendations generated automatically by the system include lifestyle, dietary, nutritional supplements, herbal interventions, and toxin elimination procedures. When required, a practitioner referral can be made. As discussed in detail below, MySQL is employed in the preferred embodiment for the database, although any similar type database could be used to achieve substantially the same results. In accordance with the invention, using personal demographic, current diet, current drug therapy, home and job environment information, the presence of disease, as well as signs and symptoms and, where available, laboratory and genomic tests, the system is able to determine which systems are dysfunctional and provide personalized recommendations for restoring normal system function.

In more detail, the use of “smart questions” generated by the expert system hones the probabilistic reasoning of the expert system. The expert system's decision to ask “Smart Questions” of the user is determined by which nodes are probabilistically triggered by the input information. Technically, the expert system in the preferred embodiment is generally classified as a “frames-based” inference engine as opposed to a rules-based, neural network, fuzzy logic or other expert systems.

Thus, in accordance with the invention, a computer implemented system for generating health care recommendations to correct system dysfunction is provided. The system has a first computer with a processor that executes a health care expert system and a database for storing one or more pieces of health care information used by the expert system to generate health care recommendations. The system also has a second computer connected to the first computer by a computer network wherein the second computer has a processor that executes a software application for receiving a user interface from the first computer over the computer network and wherein the second computer communicates user related health information to the first computer using the user interface and the expert system generates one or more health care recommendations for the user based on the user related health information.

In accordance with another aspect of the invention, a computer implemented method for generating health care recommendations to correct system dysfunction using a health care expert system and a database for storing one or more pieces of health care information used by the expert system to generate health care recommendations is provided. The method comprises receiving a user interface, communicating user related health information to the computer using the user interface, and generating health care recommendations using the health care expert system for the user based on the user related health information.

In accordance with yet another aspect of the invention, a computer implemented system for generating health care recommendations to correct system dysfunction is provided wherein the system is contained in one or more instructions that are executed by a processor of a computer system. The system comprises a health care expert system, a database for storing one or more pieces of health care information used by the expert system to generate health care recommendations, and one or more instructions that receive user related health information and one or more instructions that generate health care recommendations for the user based on the user related health information.

In accordance with still another aspect of the invention, a computer-implemented health care expert system is provided. The expert system comprises one or more input nodes wherein each input node comprises a piece of health information input into the expert system and one or more damaging factor nodes wherein each damaging factor node comprises a cause of dysfunction. The expert system further comprises one or more concept nodes wherein each concept node comprises an abstract dysfunction of a user, one or more endnode nodes wherein each endnode node comprises a dysfunction of a user at a physiological level, one or more intervention nodes wherein each intervention node comprises an intervention to repair a dysfunction of the user, and one or more links between the nodes of the expert system, each link from a first node to a second node indicates the probability of the piece of evidence in the first node indicating the piece of evidence in the second node.

In accordance with another aspect of the invention, a computer-implemented health care expert system is provided. The expert system comprises one or more input nodes wherein each input node comprises a piece of health information input into the expert system, one or more damaging factor nodes wherein each damaging factor node comprises a cause of dysfunction, one or more concept nodes wherein each concept node comprises an abstract dysfunction of a user, one or more endnode nodes wherein each endnode node comprises a dysfunction of a user at a physiological level and one or more intervention nodes wherein each intervention node comprises an intervention to repair a dysfunction of the user. The expert system further comprises one or more links between the nodes of the expert system, each link from a first node to a second node indicates the probability of the piece of evidence in the first node indicating the piece of evidence in the second node, and wherein the nodes and links of the expert system are stored in a relational database with each node and each link being stored in a table of the relational database.

### BRIEF DESCRIPTION OF THE DRAWINGS

FIG. 1 is a block diagram illustrating an example of an implementation of the preferred embodiment of the computer-implemented personalized health care advice system in accordance with the invention;

FIG. 2 is a block diagram illustrating more details of a client computer that is part of the personalized health care advice system of FIG. 1;

FIG. 3 is a block diagram illustrating more details of the server computer that is part of the personalized health care advice system of FIG. 1;

FIG. 4 is a diagram illustrating more details of the server computer that is part of the personalized health care advice system of FIG. 1;

FIG. 5 is a diagram illustrating a summary of the health care advice process in accordance with the invention;

FIG. 6 is a logic diagram illustrating the personalized health care advice system in accordance with the invention;

FIG. 7 is a diagram illustrating the node relationships of the expert system in accordance with the preferred embodiment of the invention;

FIGS. 8A-8L are diagrams illustrating the data structures associated with the nodes and links of the preferred embodiment of the expert system in accordance with the invention;

FIG. 9A is a diagram illustrating an example of the operation of a node of the expert system in accordance with the invention;

FIG. 9B is a diagram illustrating an example of the operation of a node of the expert system in a preferred embodiment of the invention using Bayesian probability;

FIGS. 9C and 9D illustrate two additional examples of the operation of a node of the expert system; and

FIGS. 10A-10Q are diagrams illustrating an example of the preferred embodiment of the user interface of the health advice system in accordance with the invention.

### DETAILED DESCRIPTION OF A PREFERRED EMBODIMENT

The invention is particularly applicable to a web-based expert computer system for providing health care advice and it is in this context that the invention will be described. It will be appreciated, however, that the system and method in accordance with the invention has greater utility since it can be implemented using other computer systems and other expert systems. For example, the system may be implemented in various different manners including packaged application software, packaged component software, integrated middleware, generic and specific client-server implementations, distributed implementations including traditional web, newer web services, proprietary implementations and distributed services to all clients including but not limited to personal computers, personal digital assistants (PDA), cellular phones and newer information appliances.

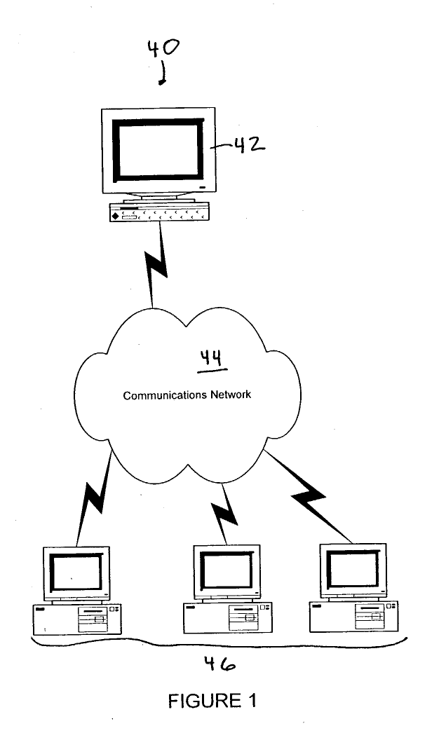

FIG. 1 is a diagram illustrating a preferred embodiment of a personalized health care advice system 40 in accordance with the invention. The system 40 may include a server computer 42 which is connected to a communications network 44, such as the Internet/Web in a preferred embodiment, which is in turn connected to one or more client computers 46. The communications network uses a typical well known communications protocol, such as HTTP or HTTPS and TCP/IP, to provide secured communications between the server computer 42 and the one or more client computers 46. In a preferred embodiment, each client computer may access the server computer and establish a connection with the server computer using a well known URL. The server computer 42 may provide a plurality of web pages to each client once a session is established between the client computer and the server computer. The server computer typically handles multiple sessions with multiple client computers simultaneously. The web pages provide information and a user interface to the user of the client computer and permit the user of the client computer to interact with the server computer. For example, in the personalized health care advice system, the web pages may present the user with one or more smart questions, as described below, which are used by an expert system in the server computer to determine further questions for the user and to determine the physiology of the user based on the answers to those questions. The invention is not limited to any particular computer architecture and may be implemented using other architectures, such as a web services architecture or a packaged software architecture. The invention can also be implemented on a stand-alone computer system or it can be placed onto a piece of portable media, such as a CD, so that the system may be implemented by executing one or more program(s) residing on the portable media.

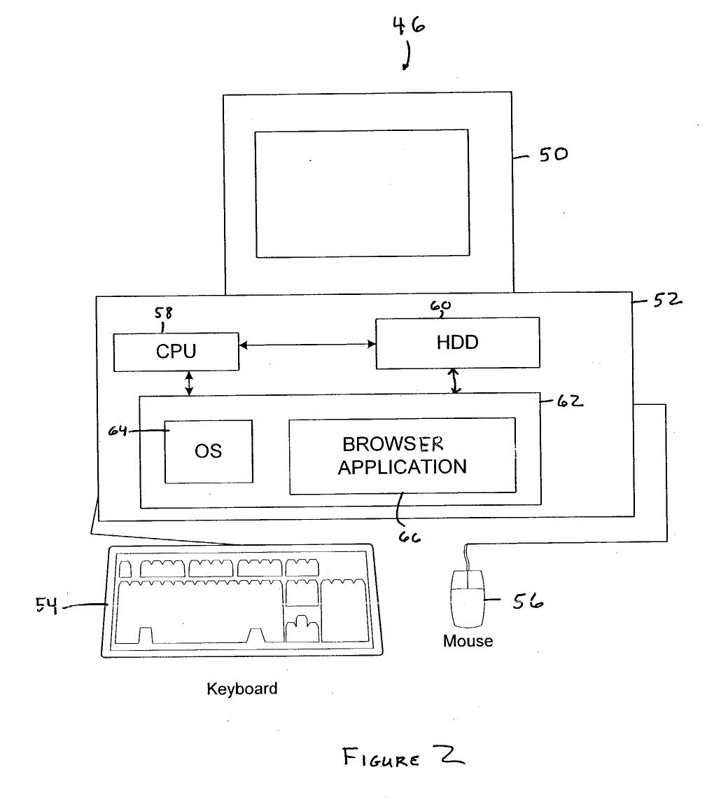

FIG. 2 is a diagram illustrating more details of the client computer 46 which may be a typical personal computer in a preferred embodiment. The invention, however is not limited to the client computer shown and may be implemented using a variety of different computing resources, such as a laptop, notebook, personal digital assistant (PDA), cellular phone or workstation, which have sufficient computing power and an Internet or other connection (whether wired or wireless) to connect to the server computer. The client computer may also be another server computer which is accessing the personalized health care advice system such as in a peer-to-peer system.

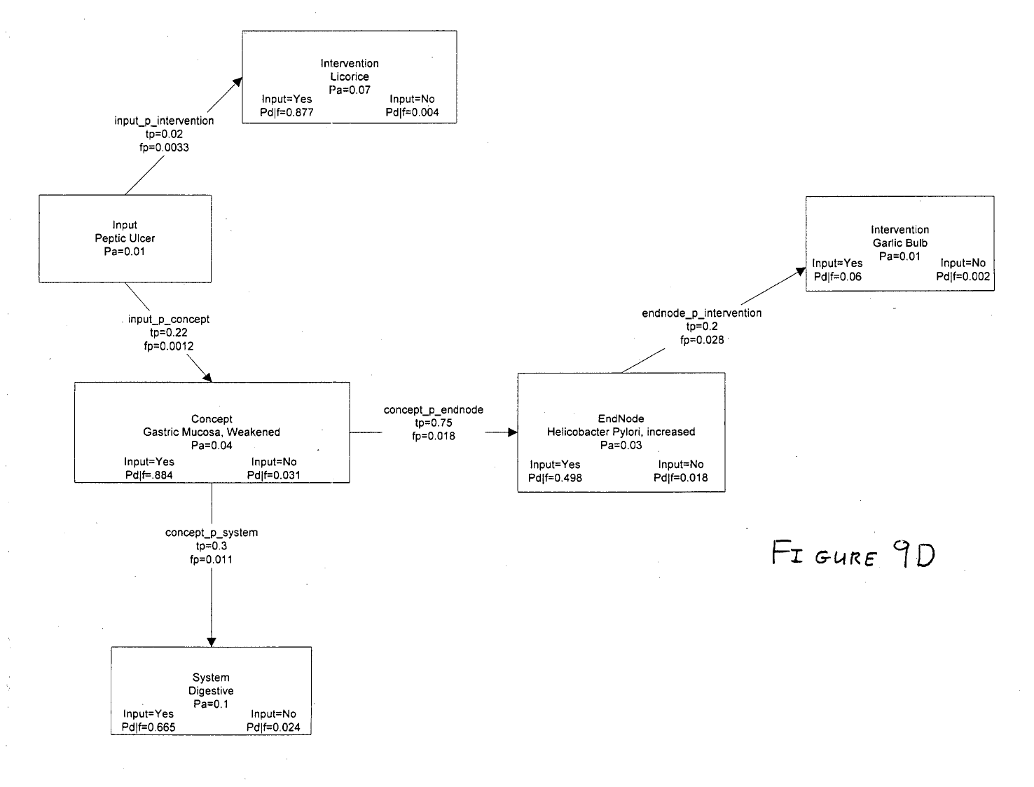

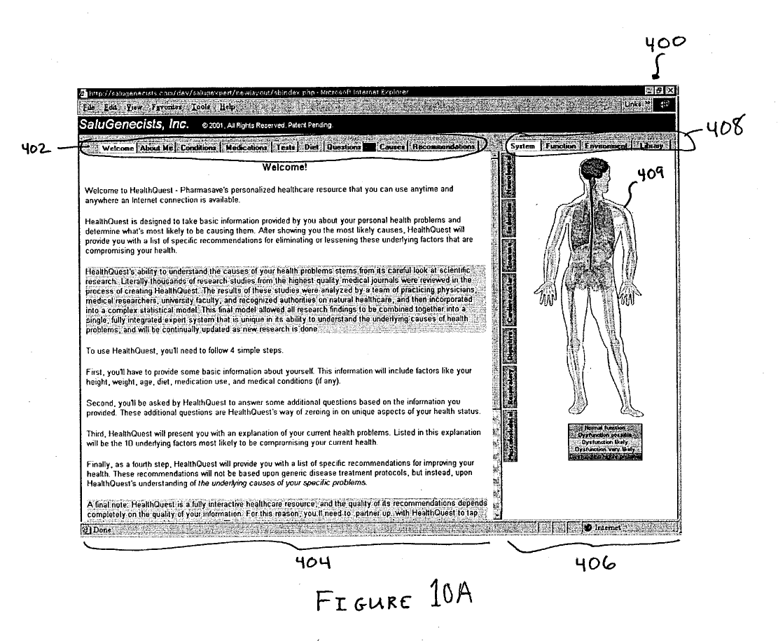

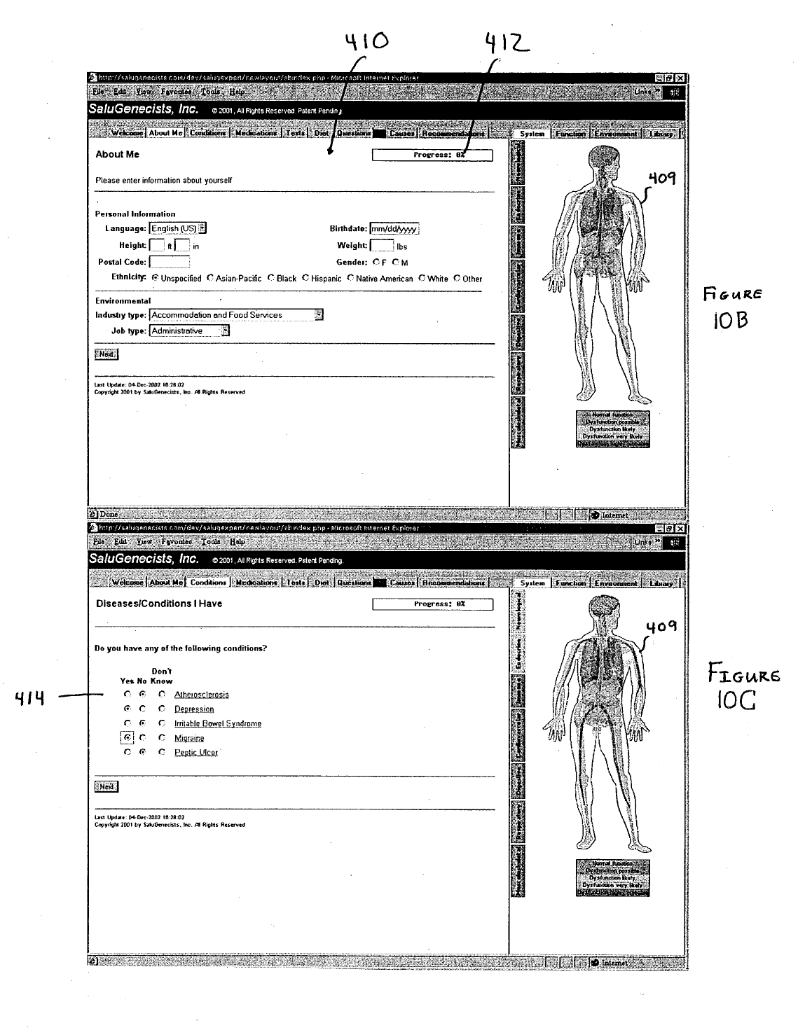

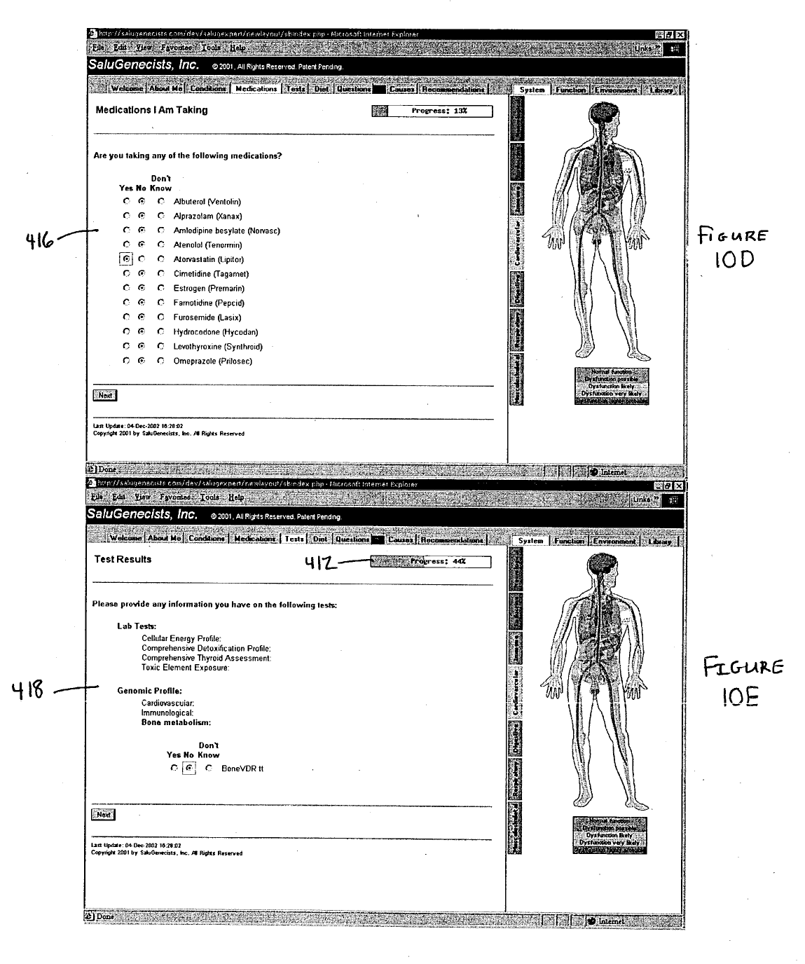

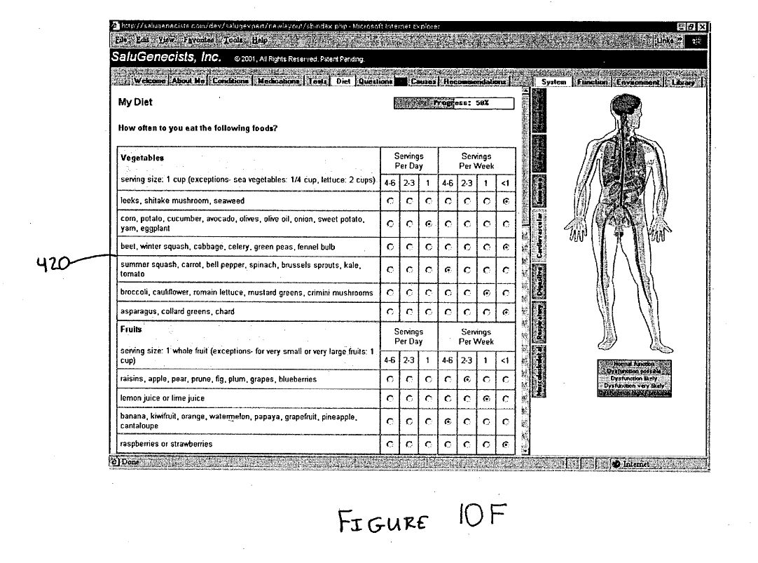

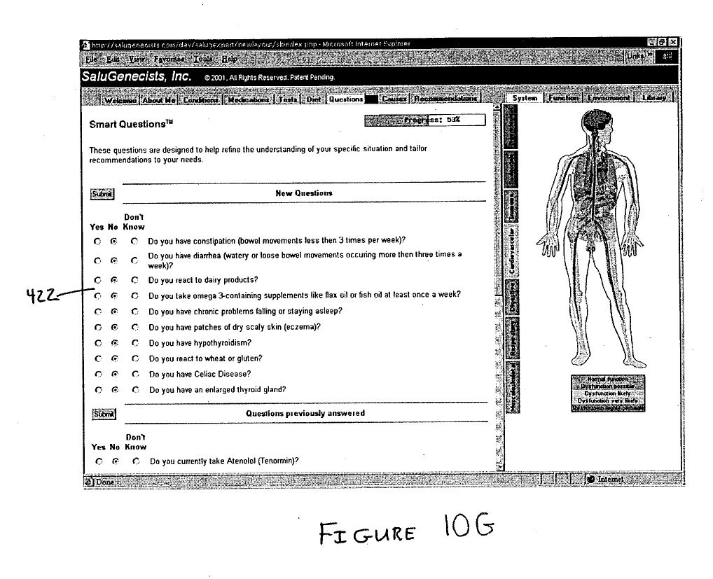

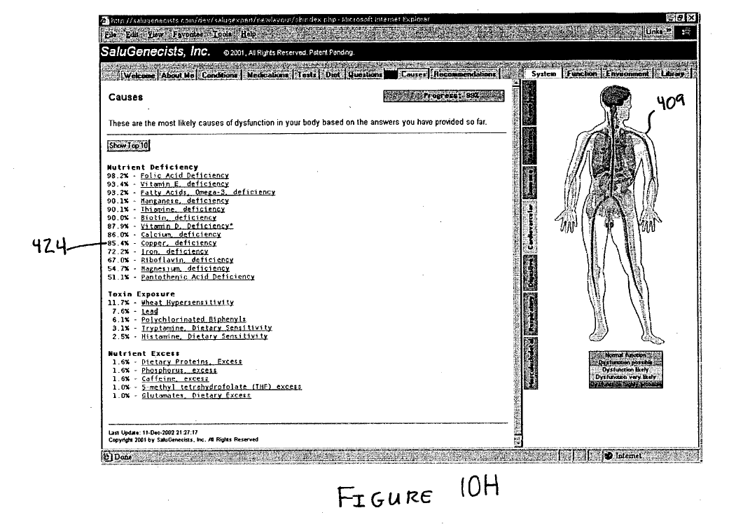

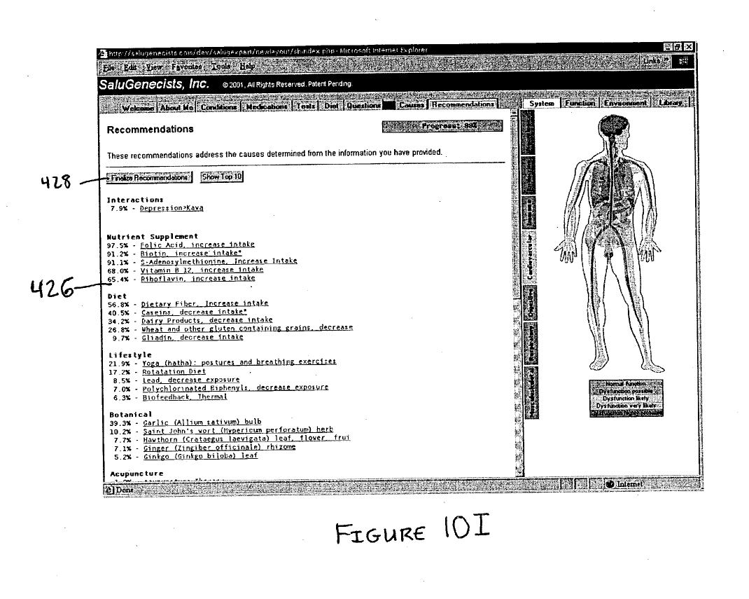

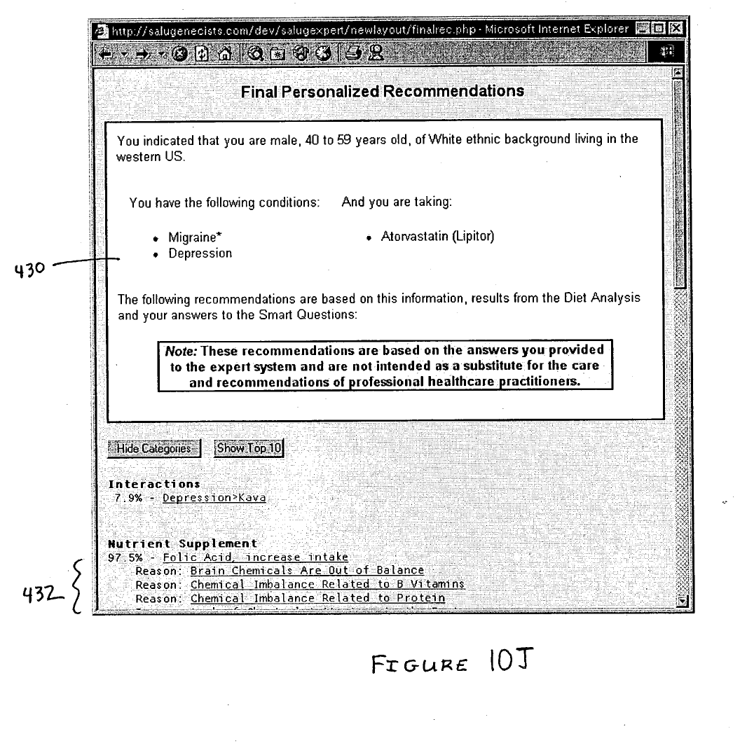

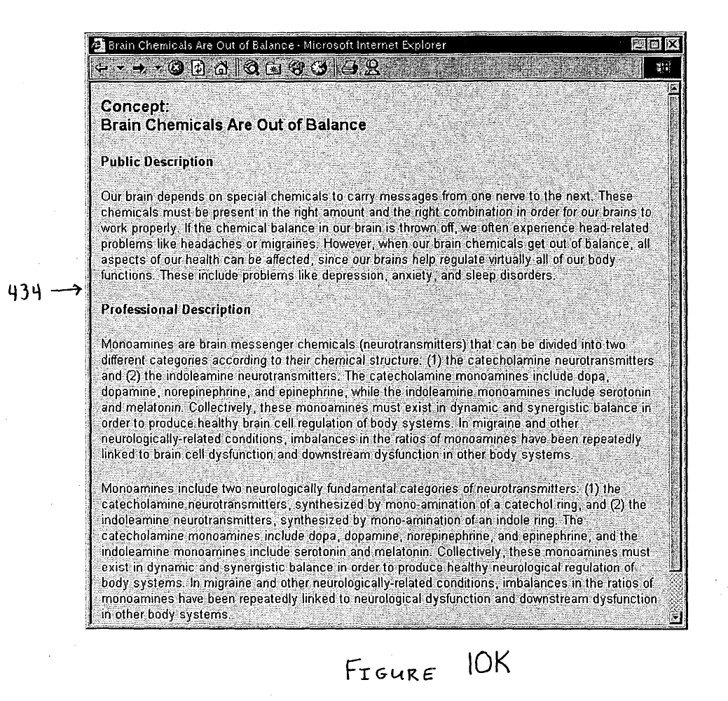

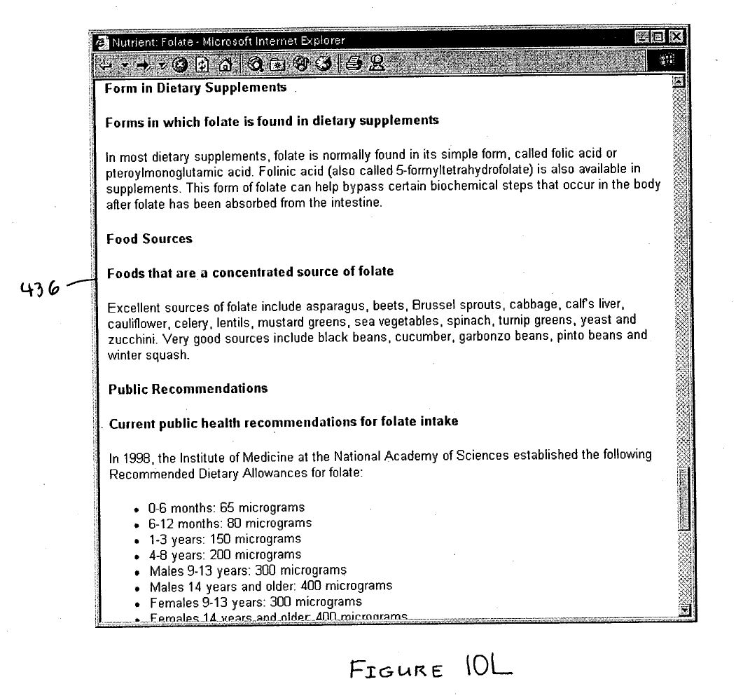

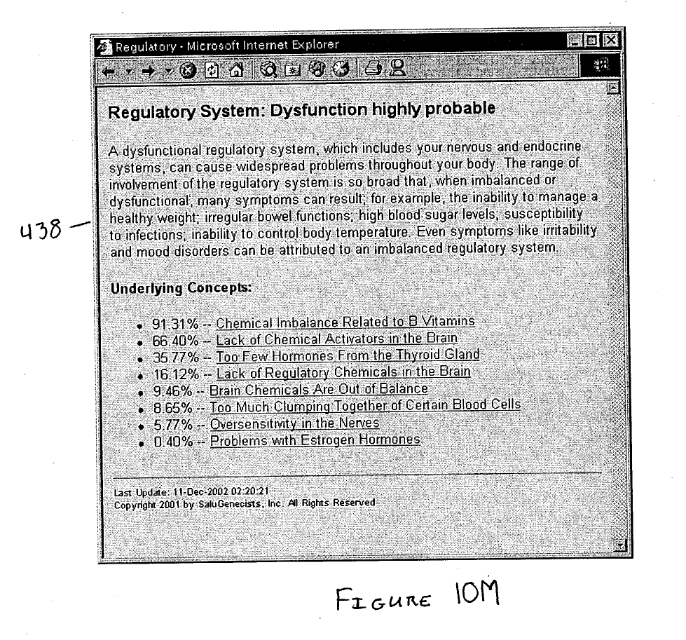

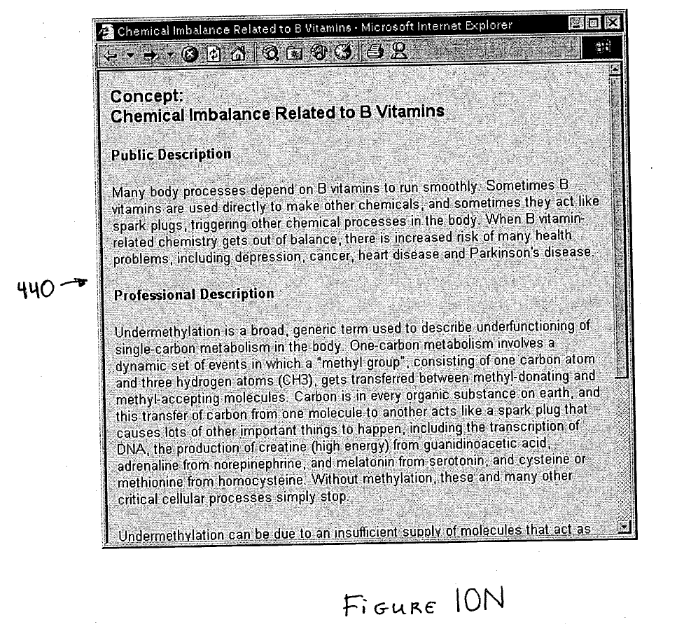

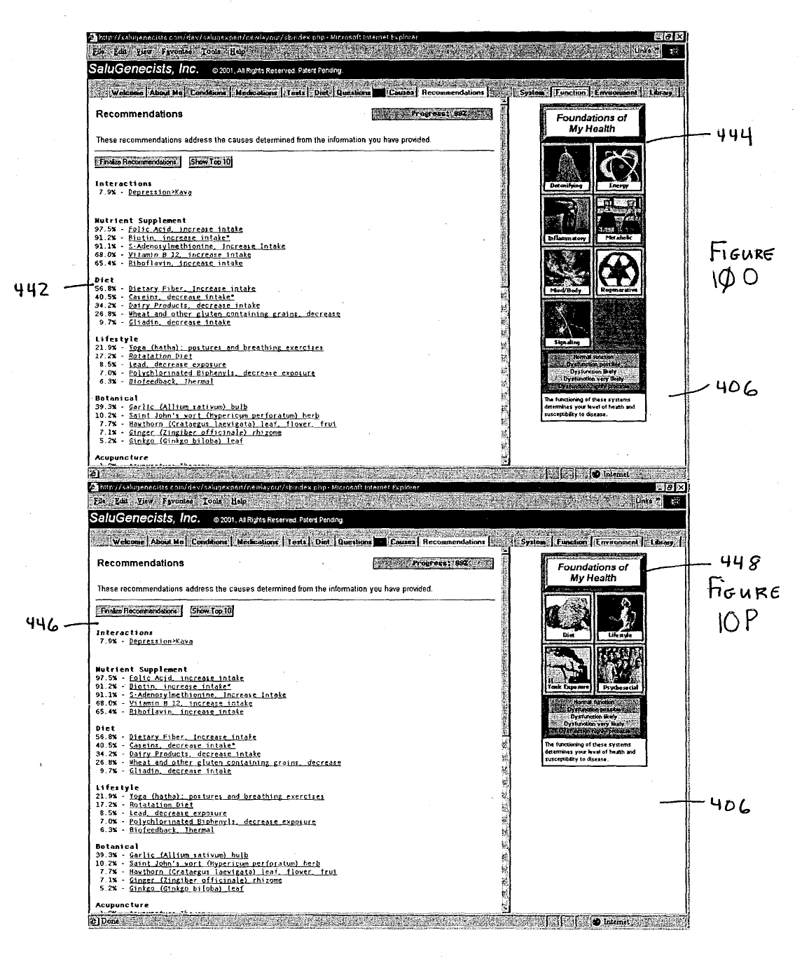

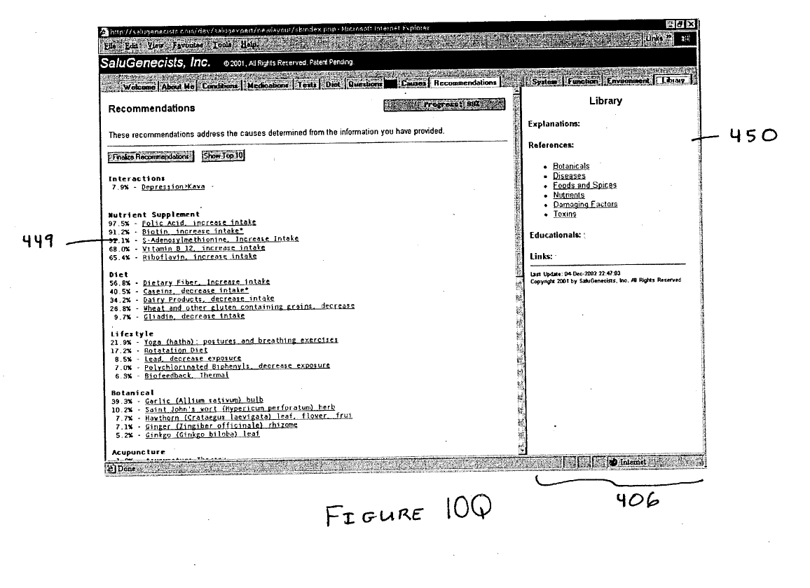

Returning to FIG. 2, the client computer may include a display device 50 (such as an cathode ray tube or liquid crystal display) for viewing the data and user interface of the computer, a chassis 52 and one or more input/output devices, such as a keyboard 54 and a mouse 56 shown in FIG. 2, which permit the user to interact with the computer system, enter data into the computer system and perceive the data being output from the computer system. The chassis 52 may further include at least one central processing unit (CPU) 58 that controls the operation of the computer system as is well known, a persistent storage device 60, such as a hard disk drive, an optical disk drive, a removable media device, etc. which stores data even when the computer system is powered down, and a memory 62, such as DRAM or SRAM, which temporarily stores data as long as the computer system is operating and typically stores data that is currently being executed by the CPU. The data stored in the persistent storage device and memory may include application program(s) code as well as the data associated with the application program(s). In the example shown in FIG. 2, the memory may store at least operating system code 64 and a browser application 66. The browser application permits the computer system to establish a connection with and access the applications on the server computer. Although not shown, the client computer also has a connection to the Internet, such as a dial-up modem, a cable modem, a DSL line, a wireless modem or a wireless link which permits access to the server computer. As is well known, the browser application, such as Netscape Navigator or Microsoft Explorer, permits the user to establish a connection to the server computer, by using a well known URL and a well known communications protocol, such as HTTP, and then the browser application receives web page(s) from the server computer which are displayed to the user as the user interface. An example of the web-based user interface displayed on the client computer for the personalized health care advice system is shown in more detail below with reference to FIGS. 10A-10Q.

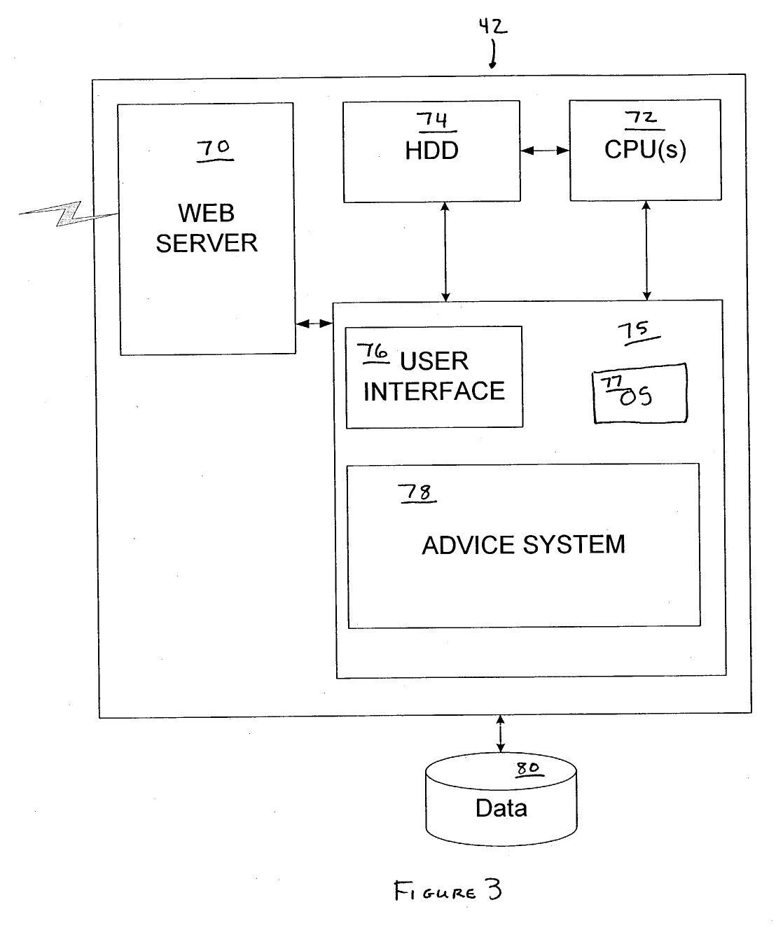

FIG. 3 is a diagram illustrating more details of the server computer 42 of the preferred embodiment of the invention. The server computer 42 may include a well known web server 70 which generates the web pages that are sent to the client computers. The server computer 42 may further include one or more CPUs 72, one or more persistent storage device(s) 74 and a memory 75. In order to implement the personalized health care advice system in accordance with the invention, the memory may store a user interface 76 which is communicated to the user as one or more web pages, an operating system (OS) 77 and an advice system 78. The server computer may further include a database server 80 connected to the server computer which stores a database that is utilized by the personalized health care advice system as described below in more detail. For example, the database may include the nodes and links used by the expert system in the preferred embodiment of the invention as well as the content and knowledge utilized by the expert system.

The preferred embodiment of the health advice system 78 incorporates an expert system designed and programmed in a unique manner using web-based tools and databases to create an expert system. The operating system used in the preferred embodiment of the invention on the web sever is Linux in combination with the Apache web server software, both of which are open source and well known. The database being used in the preferred embodiment of the invention is MySQL, although any similar type database could be used to achieve substantially the same results. MySQL is a relational database which is open source, fast, multi-user, multi-threaded, robust and excellent for website use. It uses the SQL (Structured Query Language), the standard database query language used worldwide. Although PHP (the chosen scripting language used to implement the personalized health care advice system in a preferred embodiment), Apache and MySQL have been optimized to work most efficiently with Linux, a person of ordinary skill in the art would appreciate that other combinations of software and hardware will work equally well and have been contemplated by and fall within the scope of the present invention. The expert system is accessed by users through the Internet using standard browsers, such as Internet Explorer and Netscape, as described above.

This method of programming not only meets the specific needs of our smart health advice tool, but also is fast and secure as Linux and MySQL are state-of-the-art secure web systems. The website, health content and expert system in the preferred embodiment are inaccessible without a proper username and password. In addition, the programs and system logic are not accessible without approval by the site administrator, are extensible (i.e. there is no significant limit to the number of users who can simultaneously access the expert system) and work well in a web environment. In accordance with the invention, the capacity of the system can be easily scaled by adding web servers, database servers and bandwidth as capacity is needed.

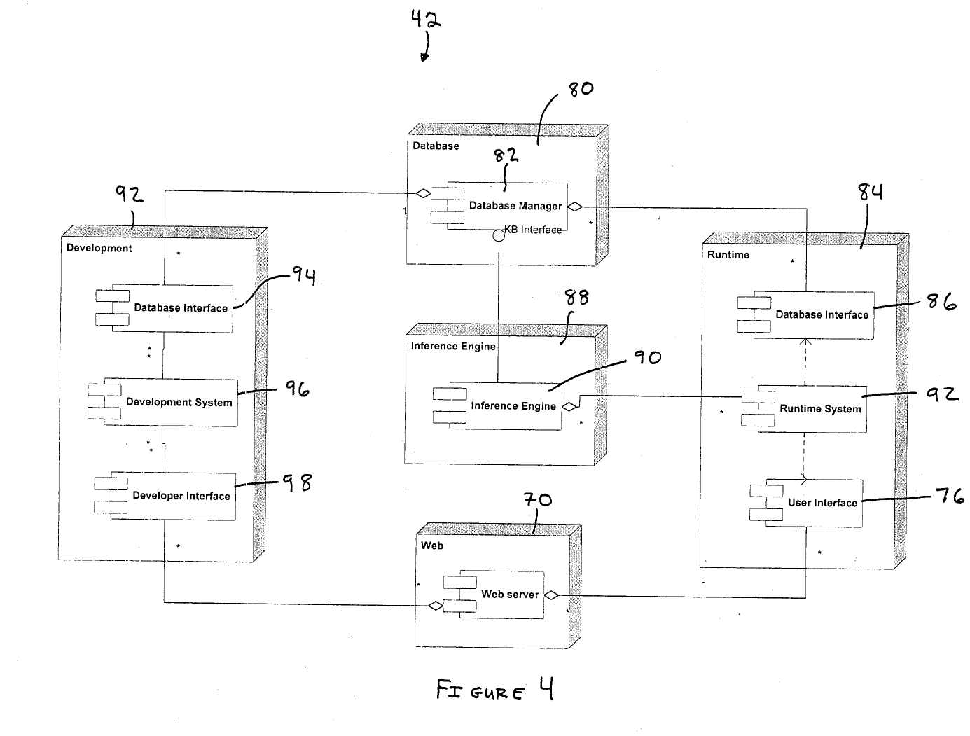

FIG. 4 is a diagram illustrating more details of the server computer 42 that is part of the personalized health care advice system of FIG. 1. The server computer 42 may include the web server 70 described above which generates the user interface 76 provided to the user in the form of one or more web pages in the preferred embodiment as well as the database 80 which includes a well known database manager application 82. The server may also include a runtime module 84 which may include a database interface 86, a runtime system 92 and the user interface 76, an inference engine module 88 that includes an inference engine 90 and a development module 92 that may include a database interface 94, a development system 96 and a developer interface 98. The runtime module 84 is the front end of the system which generates web pages (the user interface 76) from the web server 70. The runtime system 92 of the runtime module is generated based on the inference engine 90 results as shown. The database interface 86 is coupled to the database manager 82 as shown wherein the database interface may receive the user's responses and forward those responses to the database manager 82 which will in turn provide the data to the inference engine 90 and generate any database query commands. The development module 92 permits an administrator/developer to further develop the system. For example, as further knowledge is discovered that is relevant to the health care advice, the knowledge may be loaded into the database using the database interface 94 and the inference engine may be modified to handle the new knowledge. Further, the development module 92 permits the user interface generated by the web server 70 to be updated/modified.

In accordance with the invention, the user's environmental exposure, diet and current drug therapy, the presence of disease, as well as signs and symptoms and, where available, laboratory tests are used by the expert system to determine which systems of the user are dysfunctional. The system, as described above, uses “smart questions” generated by the expert system to hone the probabilistic reasoning. The expert system decision to ask “Smart Questions” of the user is determined by which nodes in the database are probabilistically triggered by the input information. Technically, the expert system is generally classified as a “frames-based” inference engine. This is in comparison to other types such as rules-based, neural networks, fuzzy logic, etc. Each record in the database represents a node or link in the expert system. Now, the overall health care advice process flow in accordance with the invention will be described in more detail.

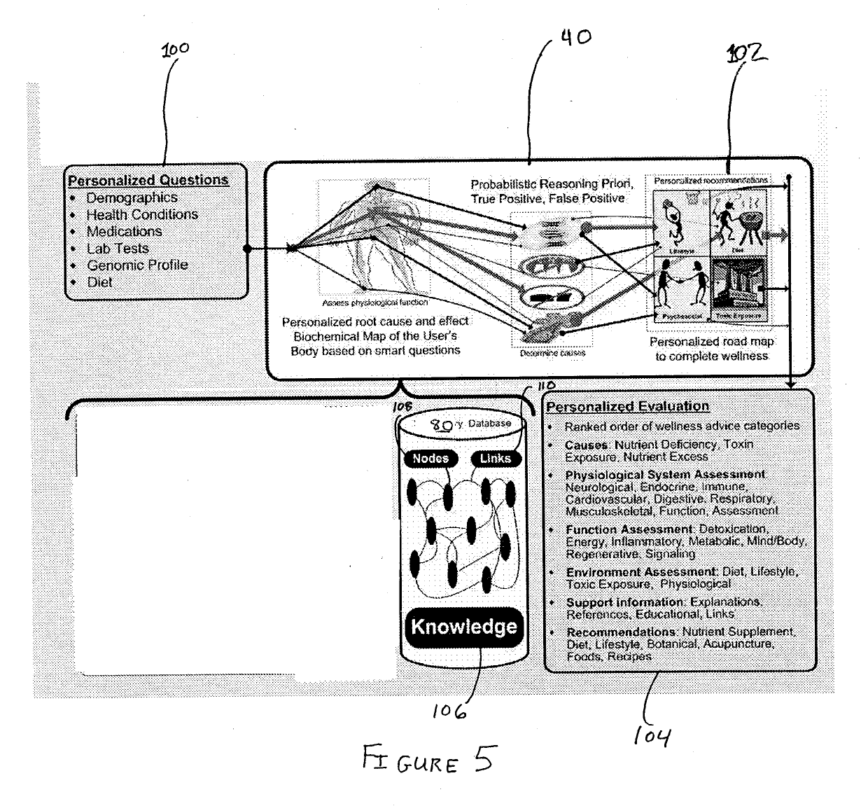

FIG. 5 is a diagram illustrating the overall health care advice process flow in accordance with the invention. The system 40 (including its expert system and its user interface) is shown wherein it receives input 100 in the form of personalized questions for each user. As shown, those personalized questions may include demographic information, health condition information, signs and symptoms, medication information, lab test information, genomic profile information and diet information. Examples of this information is shown below in more detail. As shown, the information from the personalized questions may be fed into the system. The system analyzes the information using the expert system in order to map the user's unique physiological status and determine personalized root cause of physiological dysfunction (a map of the user's unique physiological function is displayed by physiological system to the user as part of the system's user interface as described below). The biochemical map will identify systems within the user's body, such as the digestive system, detoxification system, etc., that might have some type of dysfunction based on the information obtained from the user in response to the questions. Using the information generated for the biochemical map, the causes of the dysfunction is determined using probabilistic reasoning as described below in more detail. The probabilistic reasoning output 102 is one or more personalized health recommendations which act as a personalized roadmap to complete wellness. As shown, the output may include a personalized evaluation 104 when the process is complete which may include causes, physiological system assessment, function assessment, environment assessment, support information and recommendations. Recommendations are rank-ordered across intervention types so that the user will be provided with the recommendation (whether a botanical intervention or a lifestyle change) that is more likely to be effective for the user.

The system 40 may include the database 80 which may include a knowledge base 106, one or more nodes 108 and one or more links 110 wherein the links interconnect the nodes as shown. These nodes and links are used to implement the expert system. In particular, the expert system consists of the knowledge base 106 and an inference engine 88 (shown in FIG. 4). The knowledge base is composed of groups of closely related information, known as nodes 108, and relationships between these groups of information, known as links 110. The nodes contain questions, content, system status, decisions, recommendations etc in the expert system while the links are the probability that they are related. The nodes may contain static information or may contain questions to be presented to obtain user-specific information such as demographics, presence of diseases, dietary and lifestyle information. The links provide relational information for activating related nodes and are primarily probabilistic. These links may be static but, more often, define statistical relationships (Bayesian or Boolean) between nodes. The inference engine accesses nodes and links in the knowledge base to interact with the user and determine a “current state.” This current state reflects the state of activation of all nodes in the knowledge base. The “current state” might be understood as a current map of the user's unique biochemical and health system functioning. The more information that the person provides through the Smart Question process, the more accurately the system is able to describe the person's unique physiology. Each refinement in the understanding is represented by a new “current state. The inference engine determines how the interaction with the user proceeds. The user is presented with a representation of the current state (a visual representation in a preferred embodiment), usually giving a summary of causes and recommendations inferred from the knowledge base and user input. As the user is prompted for, and supplies, more information, the inference engine updates the current state, revises the summary results and prompts the user for additional input to keep refining the results. This process continues until the user is satisfied with the results or until no further refinement is possible. Now, the expert system program logic in accordance with the invention will be described in more detail.

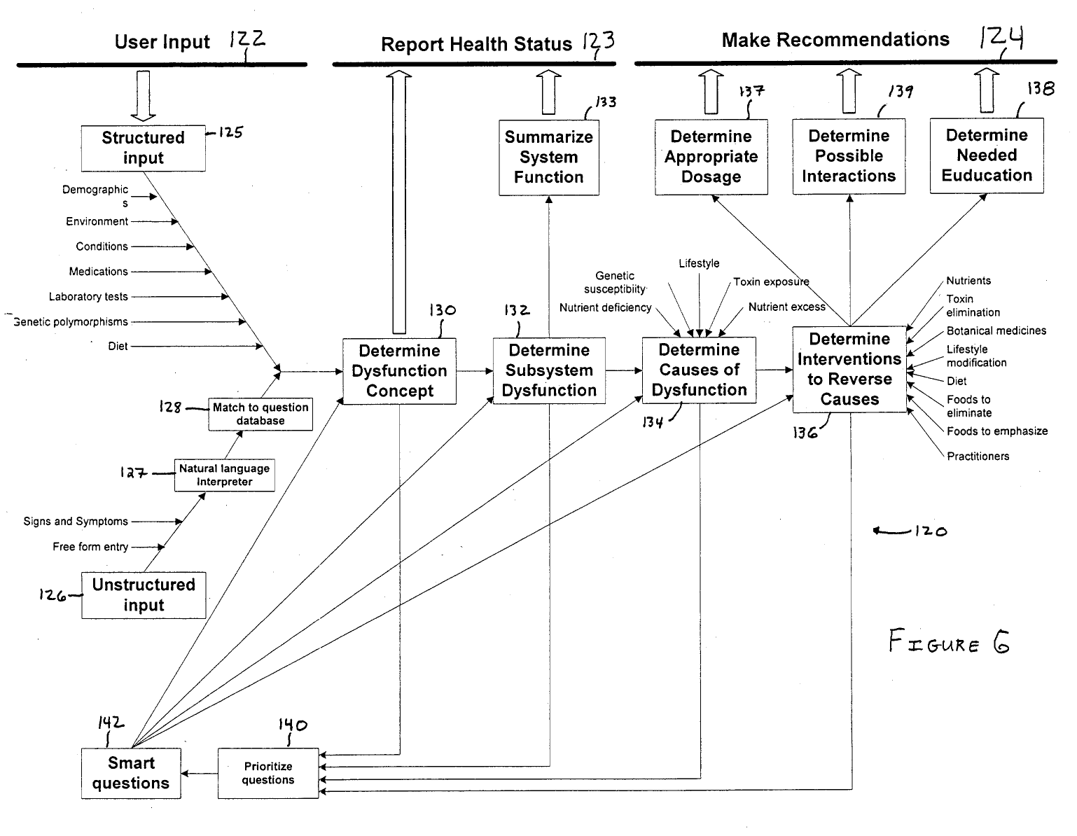

FIG. 6 is a logic diagram illustrating the expert system 120 that is part of the health care advice system in accordance with the invention. The inputs and outputs of the expert system operation as shown at the top of the diagram. These inputs/outputs may include user input information 122, report health status output 123 and make recommendations output 124. The user inputs provide information that the expert system uses to generate the health status output (e.g., what body systems have some dysfunction) and the recommendations (e.g., changes is lifestyle, suggested dosages of nutrients, etc.). The user inputs may include structured inputs 125 as well as unstructured inputs 126 as shown wherein the structured inputs may be information generated from one or more user interface forms being filled in by the user (see FIGS. 10A-10G described below for examples of the forms) and may include, for example, demographic information, environment information, conditions information, medication information, laboratory test information, genetic polymorphisms and diet information. The unstructured inputs, for example, may include free form entry (e.g., an area in the user interface in which the user is able to enter one or more sentences, phrases, etc. of information about the user) and sign and symptoms input which permits the user to enter his/her symptoms into the system in a free-form format. The unstructured input may be fed into a well known natural language interpreter 127 which processes the unstructured inputs and generates one or more key words which are then matched to a questions database 128 as shown. When this process is completed, the unstructured input information has been structured so that it can be combined with the structured input information as shown.

All of the input information for the user is fed into a module 130 to determine the dysfunction concepts. In the preferred embodiment, the dysfunction concepts are determined by a plurality of concept nodes (corresponding to the different dysfunction concepts that may exist) of the expert system which analyze the user information to determine if the particular dysfunction concept is likely to be present. The system reports a probability of any identified body system dysfunction concepts as a health status output 123. The probabilities output from the dysfunction concepts module and the other user information may be fed into a determine subsystem dysfunction module 132. In the preferred embodiment, the subsystem dysfunctions are determined by a plurality of end-nodes (each corresponding to a different specific physiological dysfunction that may exist) of the expert system which analyze the probabilities from the dysfunction concept nodes and other user information to determine if the particular subsystem dysfunction is likely to be present and outputs a probability for each subsystem dysfunction which may exist. The output from the subsystem dysfunction module 132 (the probabilities for each particular subsystem dysfunction) may be fed into a summarize system function module 133 as shown which may output a health status output 123. In a preferred embodiment, the summary function output may be a visual map of the body of the user (See FIG. 10A for an example) wherein different systems in the body are highlighted with different colors to indicate different levels of system dysfunction.

The output from the subsystem dysfunction module (the probabilities) and the other user information is fed into a determine causes of dysfunction module 134. In the preferred embodiment, the causes of dysfunctions are determined by a plurality of damaging factor nodes (corresponding to the different dysfunction causes that may exist) of the expert system which analyze the probabilities from the subsystem dysfunction nodes and other user information to determine if the particular dysfunction cause is likely to be present and outputs a probability for each dysfunction cause which may exist. The dysfunction cause module 134 may also receive nutrient deficiency information, genetic susceptibility information, lifestyle information, toxin exposure information and nutrient excess information of the user to determine the dysfunction causes probabilities. The probabilities of the dysfunction cases are fed into a determine interventions to reverse causes module 136. In the preferred embodiment, the interventions are determined by a plurality of intervention nodes (corresponding to the different interventions that may exist) of the expert system which analyze the probabilities from the dysfunction causes nodes and other user information to determine if the particular intervention is likely to improve the user's dysfunctions. In addition to the probabilities from the dysfunction causes module 134, the module 136 may also receive nutrient, toxin elimination, botanical medicine, lifestyle modification, diet, foods to eliminate, foods to emphasize and practitioner information which may be used to generate the appropriate intervention for the particular user. The intervention module 136 may generate information which is used by a determine appropriate dosage module 137, a determine needed education module 138 and a determine possible interactions module 139 which generate recommendations 124 to the user. The determine possible interactions module 139 may, based on the user's unique physiology, check for possible interactions between interventions being suggested to ensure incompatible interventions are not being made and alert the user to any potential dangerous interactions with conventional drugs the user is taking. The determine possible interactions module 139 may also minimize the side effects of conventional drug therapy since the system may generate recommendations of nutrients to help counteract one of the primary causes of drug side-effect: the nutrient deficiencies induced by drugs.

As shown, each of the modules 130, 132, 134, 136, when determining their respective probabilities, may also generate one or more questions about further information which will improve the confidence of the particular module. All of these questions are fed into a prioritize questions module 140 which prioritizes the questions from all of the modules to present only the most relevant questions to the user which are output as smart questions 142 as shown. The input from the user in response to the smart questions are fed back to the various modules 130-136. The modules 130-136 may then generate another list of questions which are fed back to the prioritize questions module 140. The smart questioning process (with the generation of lists of questions and the feed back of information generated based on the smart questions) will continue until the expert system has achieved a particular level of confidence in the recommendations and health status information or the user has elected to stop the process and receive the final recommendations from the system.

The smart question may include, for example, “Are you currently taking Cimetidine (Tagamet)?”, “Do you work in an environment which exposes you to lead?”, “Are you fatigued?”, “Are you overly sensitive to sounds?”, “Are your eyes overly sensitive to light?”, “Do you currently take albuterol (Ventolin)?” (or other drugs), “Do you experience frequent colds (more than 6 times a year)?”, “Do you feel worthless or very guilty about things constantly?”, “Do you have Asthma?”, “Do you suffer from headaches?”, “Do you take omega 3-containing supplements like flax oil or fish oil at least once a week?”, “Do you think you react to certain foods?”, “Do you work in welding, brazing, battery manufacture, radiator repair, or demolition?” and the like.

Since there will be tens of thousands of smart questions in the system, it is desirable to present users with only those questions necessary to determine their physiologic state and causes of dysfunction. To accomplish this, the system computes the total amount of meaningful information left to be gathered and how much of that information is available from each question. Unanswered questions are then ranked according to the amount of meaningful information they can provide to the system. Since the amount of information left to be gathered changes each time a question is answered, the remaining questions are re-ranked each time as the remaining information is recomputed. The amount of meaningful information available from the remaining questions is also used as a progress indicator for the user and is displayed as a bar to show progress from 0 to 100%. Typically, the user might consider the questioning complete after 90-95%.

Returning to the expert system, it provides a unique way of providing personalized health advice by diagnosing system function, rather than the presence of a disease. The system determines probabilistically, using Boolean and Bayesian logic as described below, various information about a user. The knowledge base is implemented in a relational database (mySQL in the preferred embodiment) for speed of access as well as having a structured and portable means for obtaining that access. The Linux operating system is used in the preferred embodiment, but the invention is not limited in that respect and may be used with Windows NT or other operating systems. In accordance with the invention, there are various “types” of nodes and links wherein each type of node and link is represented in a unique database table. The actual contents for nodes and links are stored as rows in the table corresponding to the respective types. The use of “typed” nodes and links in a relational model gives extreme flexibility. Any node may be related to any number of other nodes and other node types through any combination of links and link types. This mechanism provides flexibility to rapidly define many “virtual knowledge bases” that reuse nodes in the base knowledge base simply by defining a new set of links. For example, we can easily repurpose a provider-oriented knowledge base to be suitable for consumers or administrators.

The inference engine is implemented, in the preferred embodiment, in a web-friendly, database-friendly scripting language (PHP in the preferred embodiment) to simplify interaction with web browsers and the knowledge base. PHP is a well known server side scripting language designed specifically for the web. The PHP code can be embedded within an HTML page. Typically, the PHP code is interpreted by the server which in turn generates HTML code which is translated by the user's Internet browser and then displayed on their computer screen. PHP was designed for high performance, easy and efficient interface to database engines, and contains a large library of routines for common tasks. In particular, PHP has built-in specialized compatibility with MySQL allowing both direct access to the data contained in MySQL as well the more powerful SQL database queries. The inference engine supports multiple simultaneous users by creating a unique “session” for each user where the inference engine maintains the user-specific current state. The relationships contained in knowledge base links are interpreted by the inference engine and may contain any type of calculation that is appropriate. An example might be: when atherosclerosis is present, there is a 0.350 TP (True positive) probability of an inability to properly metabolize the metabolic waste product homocysteine and a 0.014 FP (False positive) probability. An elevated level of homocysteine indicates a 0.780 TP of a deficiency of vitamin B6 with an FP of 0.055. These numbers are used to recalculate the probability of a vitamin B6 deficiency for a particular user based on the other information about the user. Many relationship links are Bayesian but some need to be overridden by Boolean operations under certain conditions. For example, Boolean logic may be used instead of Bayesian logic when either 1) the exact nature of the relationship is known or the probabilities are not known; or 2) an expert estimate is used instead. An example of the first case might be when a person has arteriosclerosis, there is a 0.35 probability of excessive levels of homocysteine in the blood. If this gets measured and found to be true, a Boolean rule changes the probability to a certainty. An example of the second case might be the presence of asthma indicating a 0.333 probability of inadequate secretion of hydrochloric acid in the stomach. About 15 symptoms are known to be indicative of low stomach acid, but no research has measured how accurately any specific symptom predicts hypochlorhydria. A Boolean logic statement might be used to assign a probability based on the number of symptoms present. This flexibility in links and link types permits us to readily adapt knowledge bases for many uses. In accordance with the invention, a fully functioning expert system will have hundreds of thousands of links, each representing a probabilistic relationship.

In the preferred embodiment of the system, Bayesian probabilistic reasoning may be used. In the preferred embodiment, the Bayesian probabilistic reasoning can be simplified to essentially the following formulas:

| Formula | Description |
|---|---|
| P(D/S) = P(S/D)*P(D)/P(S) | Determining the probability of a conclusion is the |
| | primary goal of the inference engine. This is the primary |
| | calculation used by the inference engine to determine the |
| | probability of a conclusion. It calculates the probability |
| | of an inference given a particular piece of information. |
| | For example, the probability of a vitamin B6 deficiency, |
| | given that the person has elevated homocysteine levels. |
| P(D) | This is the a priori that the conclusion is correct when no |
| | other information is available. For example, the |
| | probability that a person is deficient in vitamin B6 when |
| | nothing else is known about them. |
| P(S) | This is the a priori of the provided information. For |
| | example, the percent of elevated homocysteine in the |
| | population. |
| P(S/D) = P(D/S)*P(S)/P(D) = TP | The True Positive is one of the two key statistical data |
| (True Positive) = Sensitivity) | extracted from the research literature in order to calculate |
| | the inference probabilities. |
| P(S/˜D) = (P(S) − (P(S/D)*P(D))/(1 − | The False Positive is the other key statistical data |
| P(D)) = FP (False positive) | extracted from the research literature in order to calculate |
| | the inference probabilities. |

Where the preferred Bayesian data is not available, or the conclusions are deterministic, Boolean logic may be used. For example, there are perhaps 20 symptoms of vitamin B6 deficiency. However, the probability of any one of them determining a deficiency of vitamin B6 is not known. So, if 10 of the 20 symptoms are present, we assign a probability of deficiency, most simplistically, 50% (10/20). In some situations, an exact decision can be made. For example, if a blood test for vitamin B6 shows a frank deficiency, no probabilistic reasoning is needed. Now, the nodes and links of the expert system in accordance with the preferred embodiment of the invention will be described in more detail.

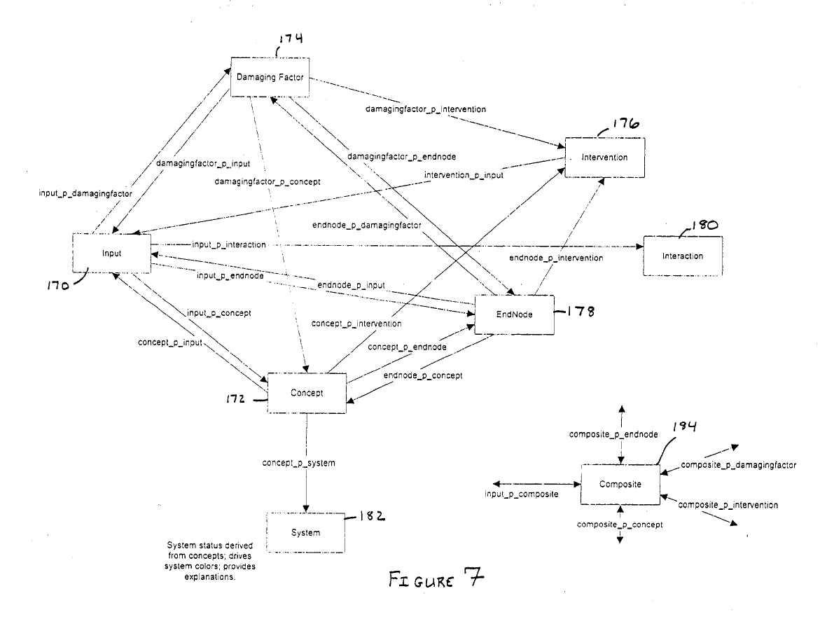

FIG. 7 is a diagram illustrating the node relationships of the expert system in accordance with the preferred embodiment of the invention. In particular, the diagram illustrates that the preferred embodiment of the expert system may include an input node 170, a concept node 172, a damaging factor node 174, an intervention node 176, an endnode node 178, an interaction node 180, a system node 182 and a composite node 184. These nodes are interconnected with each other by one or more links. As shown, the input node and damaging factor node are interconnected by a input_p_damagingfactor link from the input node to the damaging factor node as well as a damagingfactor input link from the damaging factor node to the input node. These links establish a particular relationship between these two nodes so that these two nodes interact with each other in various manners. For example, information contained in the input node may change the probability that a particular damaging factor is present for the particular user. In accordance with the invention, the database (and hence the expert system) may contain a plurality of types of input nodes with different inputs (such as information from smart questions) and a plurality of unique links for the particular type of input node to the other nodes in the expert system. In accordance with the invention, each node shown may have a plurality of different links connected to it from different other nodes. For example, there may be twenty different input nodes which affect the probability of a brain chemical deficiency contained in a particular concept node. An example of a particular input node and its links to the other nodes is shown in FIGS. 10A and 10B.

The input node 170 stores information of the user (such as information generated from the smart questions described above) which is related to the other nodes in the expert system. The information in the input nodes typically affects one or more different other nodes of the expert system and increases/decreases the probability of a system dysfunction, etc. of the user. The concept node 172 contains information about a collection of problems at an abstract level. For example, the concept node may indicate low brain chemicals in the user of the system. The information in the concept node 172 permits the system to generate system dysfunctions from the system node 182. The system node 182 contains information about system level dysfunction within the user. The information contained in the system node may be used, for example, to change the visual map of the user to indicate, for example, brain dysfunction. As the process is continued and further inputs are received, the system node 182 may continually update the visual map of the user's systems to reflect changes in the probability of dysfunction of one or more systems of the user.

The damaging factor node 174 may store information about items which may lead to a system dysfunction. The intervention node 176 contains information about each recommendation/intervention suggested by the system based on the input node, the endnode node, the concept node and the damaging factor node. For example, the intervention node may indicate a particular dosage of a particular nutrient for the user. The interaction node 180 contains information about cautionary notes and warnings to the particular user. For example, this node may indicate that a particular user, who has a particular condition, should not take a particular medicine which may worsen the condition. The warning might also be that a particular user, that takes aspirin regularly, should avoid getting cut since the aspirin thins the blood. The endnode node 178 contains information about a user's dysfunction at a physiological level. For example, the endnode node may determine that there is too little of a particular brain chemical for a particular user based on other known information about the user. Preferably, there may be as many as 5,000-10,000 endnode nodes in the expert system so that the expert system provides a deep assessment. Finally, the composite node 184 contains an action to be taken based on a set of inputs or, maybe, based on some subset of inputs. The inputs to a composite can be links from questions or any other node. In more detail, composite nodes are useful for dealing with statistical non-independence. Specifically, sequential Bayes, used throughout this system, assumes, mathematically, that when multiple links connect to a single node, the probability to be associated with that node can be computed by applying, in any order, the effects of each link independently to the current probability of the node and replacing the current probability sequentially with the results of each calculation (posterior probability). When there is considerable non-independence in the system, this process will overstate the actual probability. One approach is to combine non-independent variables (nodes) into a single value that accounts for dependencies. An example would be, “Set the probability of the composite node to 0.9 if at least 3 out of 5 inputs are present, otherwise set it to 0.1.” This avoids overstating the probability when 4 or 5 inputs are present since only 3 are necessary to determine a value. A concrete example might be, “Set the probability of measles to 0.9 if temperature elevated, muscle aches, and reddish rash; else set it to 0.001.” This example requires that all inputs be present before any change is made.

The links shown establish relationships between the nodes. The links (and the probabilities associated with the links in the preferred embodiment) are generated based on a large amount of health related literature and research. For example, a particular piece of literature may indicate that people with asthma have a excessive reactivity to sulfites some predetermined percentage of the time. An knowledge developer of the expert system would therefore create a link in the expert system between an asthma input node and a damaging factor node for sulfites so that the causal relationships between those two nodes are contained in the expert system.

To facilitate meaningful grouping of nodes for developers as well as for use in reporting results to users, several of the nodes described above are subcategorized. For example, interventions are further identified by the modality of the intervention: nutritional supplement, physical medicine, topical medicine, diet, lifestyle, etc. For example, the types of intervention nodes may include nutritional supplement, topical medicine, physical medicine, diet, lifestyle, psychological, botanical medicine, acupuncture, acupressure, hypnotherapy, biofeedback and food contaminant. The types of input nodes may include disease, signs—symptoms, lab, genetic, environmental exposure medication and profession/work. The types of damaging factor nodes may include nutrient deficiency, environmental exposure, nutrient excess, health condition, prescription medicine, over-the-counter medicine, metabolite excess, metabolite deficiency, microbial pathogen, food contaminant, food additive, microbial excess, microbial deficiency and enzyme deficiency. The types of endNode nodes (dysfunction type) may include elevated and decreased. The types of interaction nodes may include drug-botanical, drug-nutrient and botanical-nutrient. The types of system nodes may include cardiovascular, detoxification, digestive, energy production, immune, inflammatory, metabolism, musculoskeletal, psychosocial, regulatory, repair and mind-body.

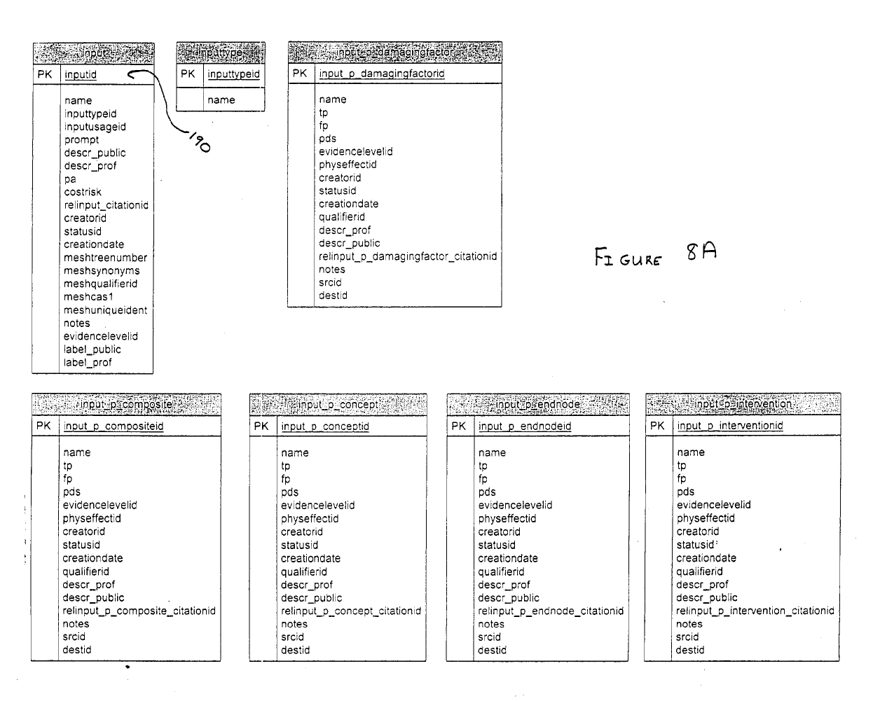

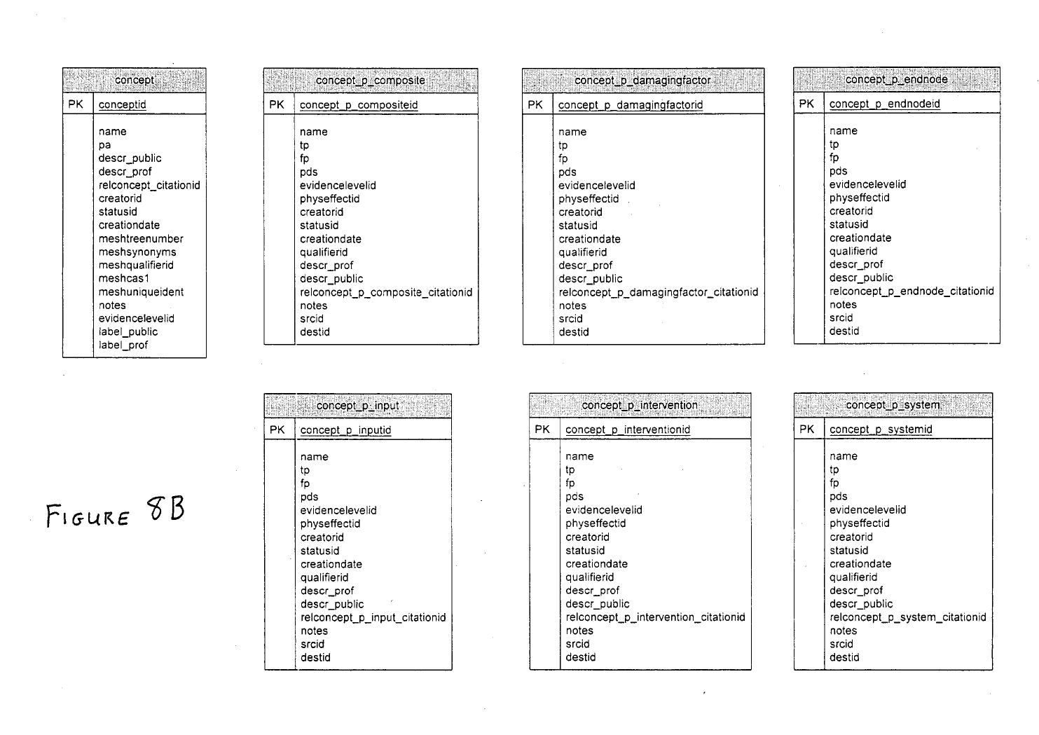

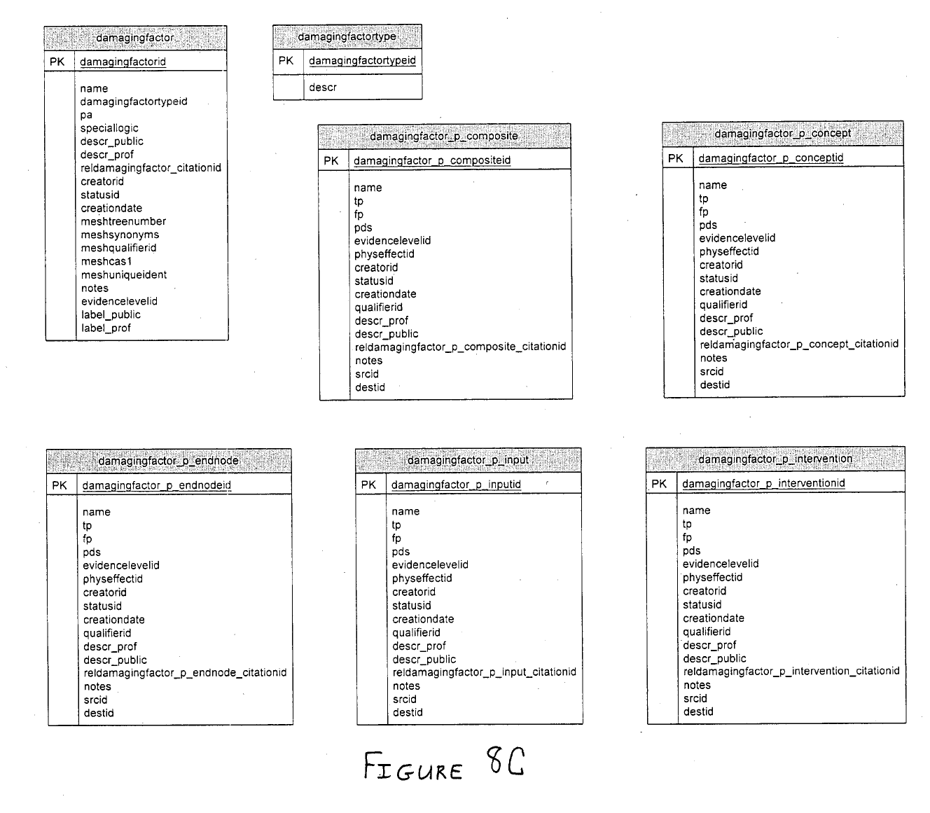

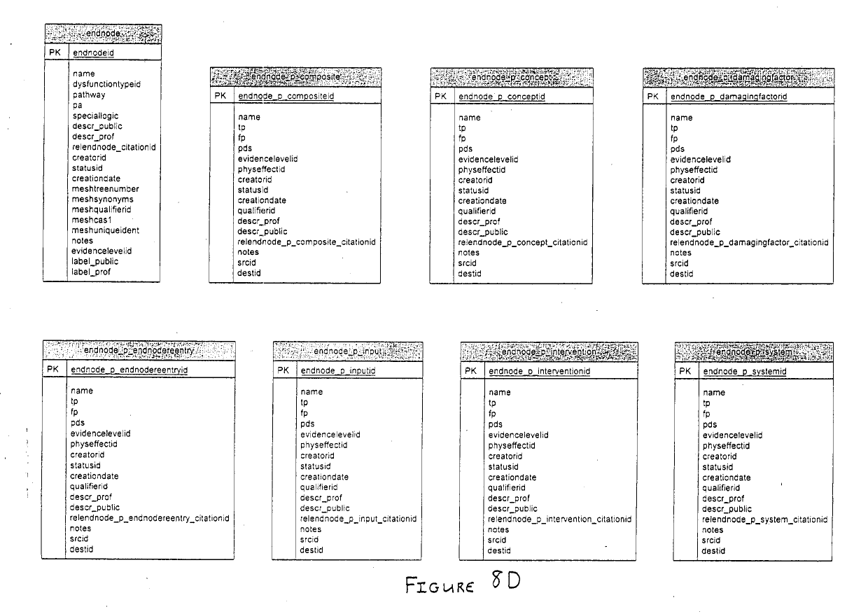

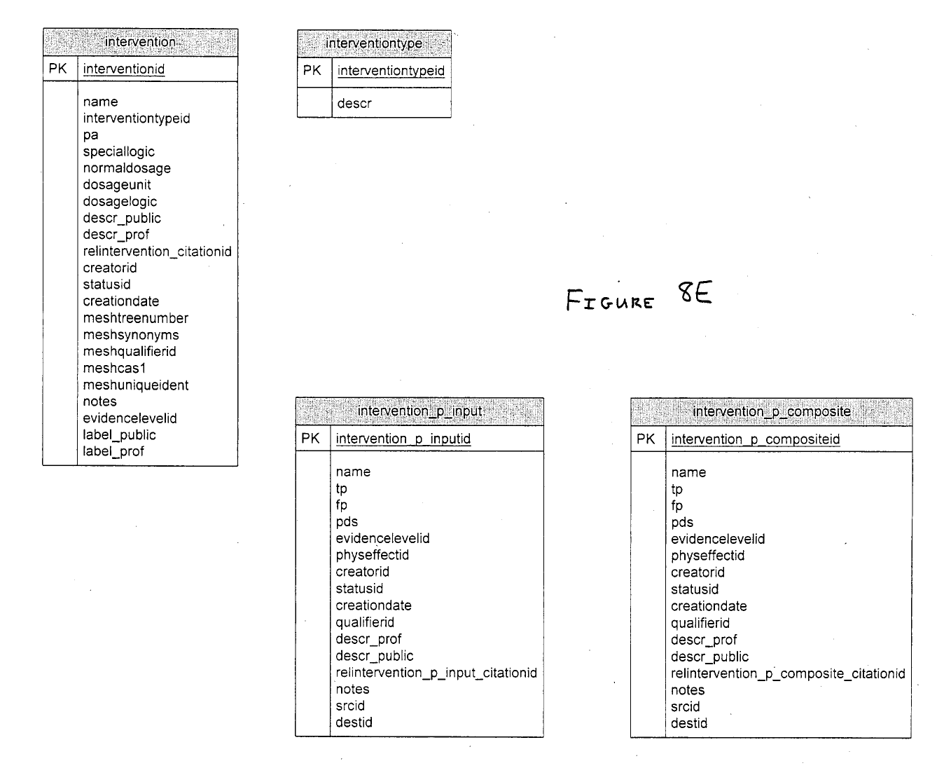

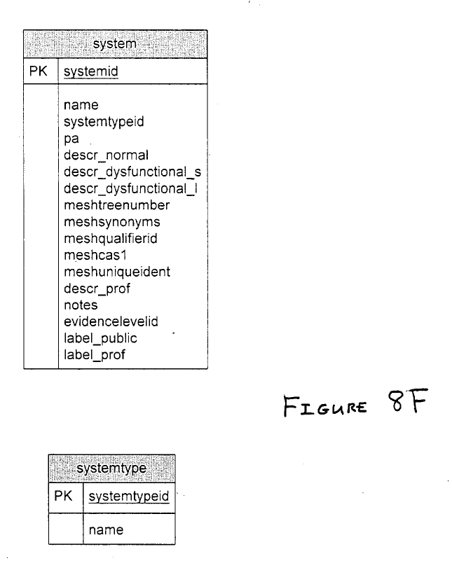

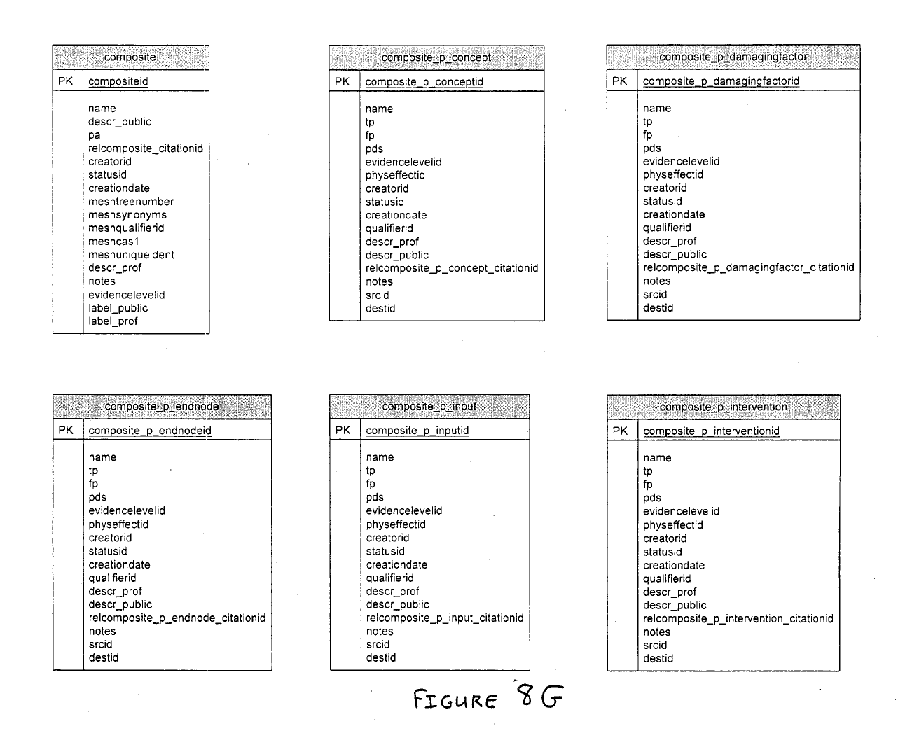

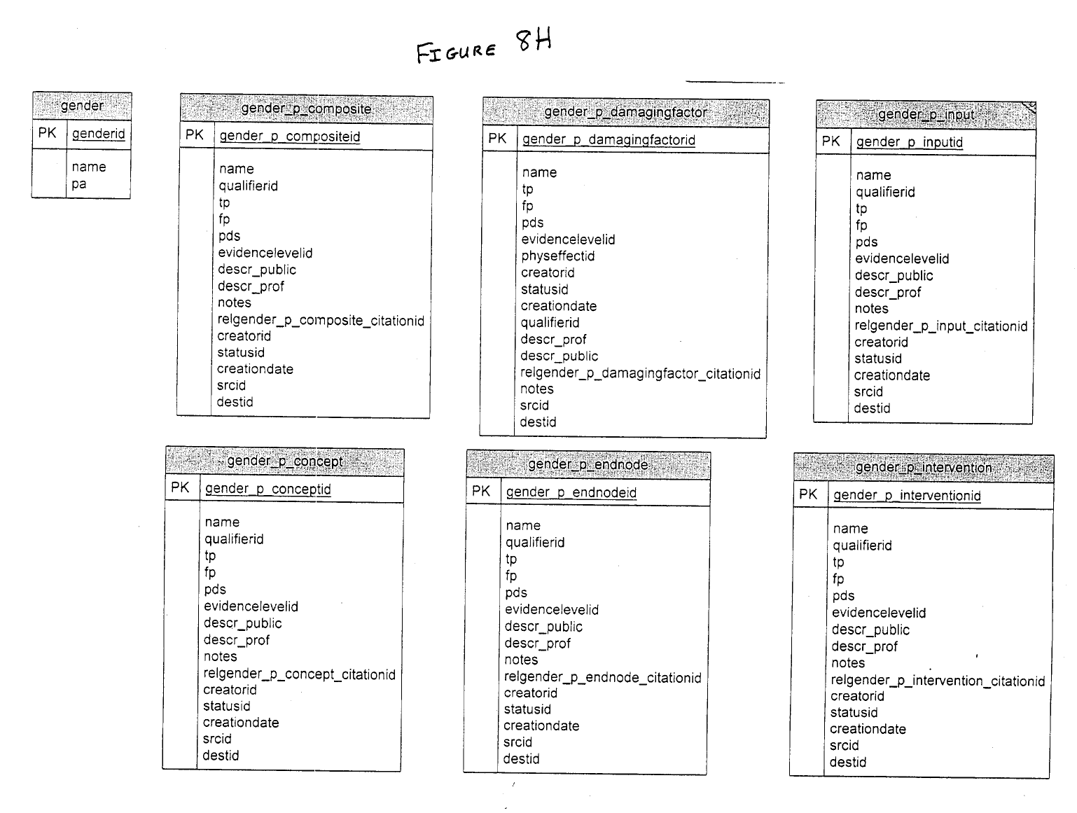

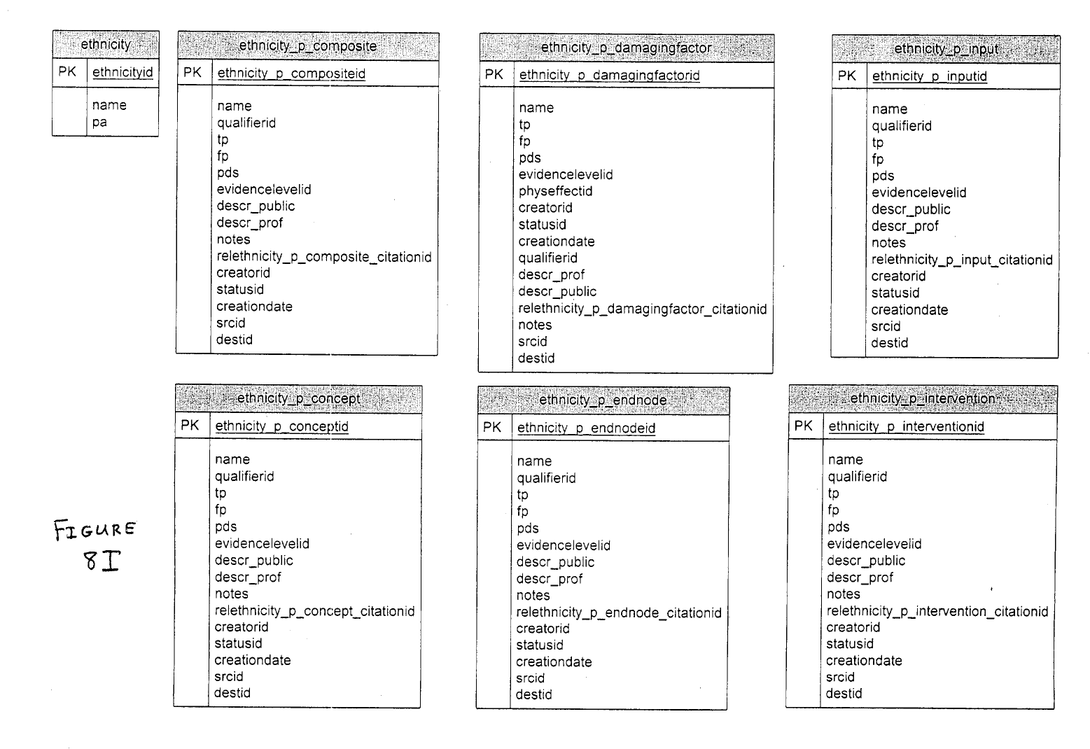

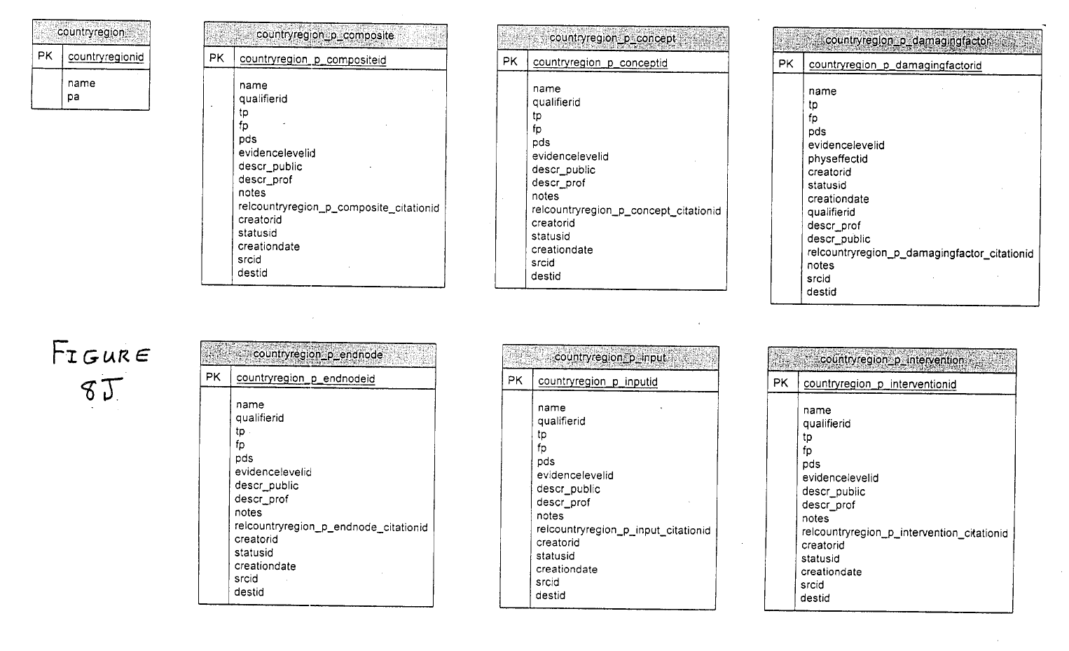

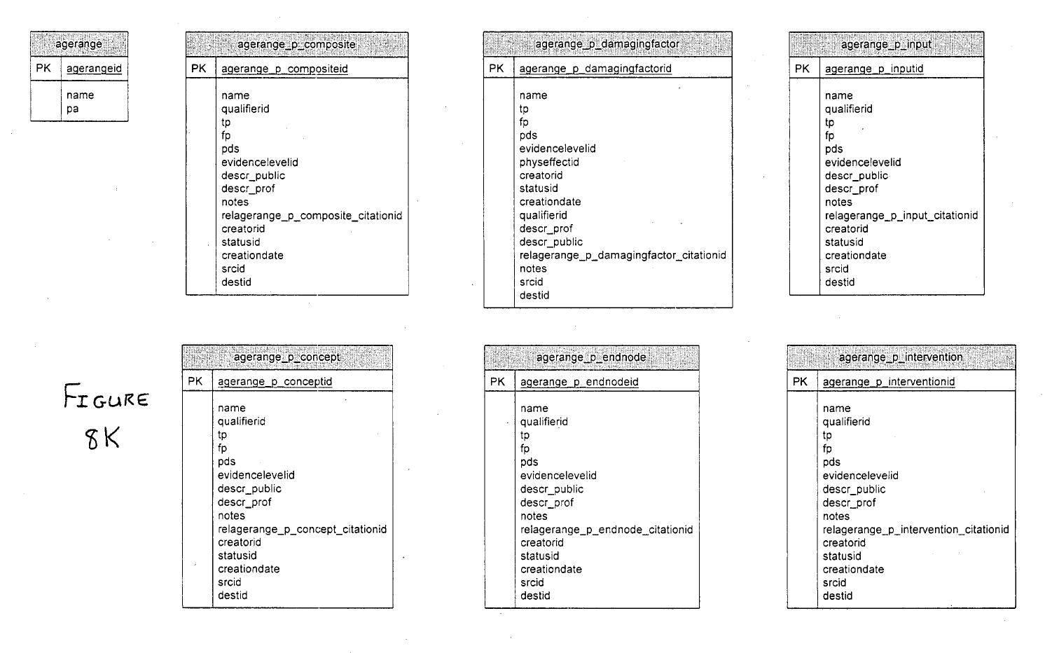

FIGS. 8A-8L are diagrams illustrating the data structures associated with the nodes and the links of the preferred embodiment of the expert system in accordance with the invention. In the preferred embodiment, these nodes and links are stored in a relational database as database tables. In particular, FIG. 8A illustrates the input node data structure and the data structure of the links from the input node to the other nodes of the system and FIG. 8B illustrates the concept node data structure and the data structure for the links from the input node to the other nodes of the system. FIG. 8C illustrates the damaging factor node data structure and the data structure for the links from the damaging factor node to the other nodes of the system, FIG. 8D illustrates the endnode node data structure and the data structure for the links from the endnode node to the other nodes of the system, FIG. 8E illustrates the intervention node data structure and the data structure for the links from the intervention node to the other nodes of the system, FIG. 8F illustrates the system node data structure, and FIG. 8G illustrates the composite node data structure and the data structure for the links from the composite node to the other nodes of the system.

FIGS. 8H-8K illustrate a gender node data structure and the data structure for the links from the gender node to the other nodes of the system, an ethnicity node data structure and the data structure for the links from the ethnicity node to the other nodes of the system, a countryregion node data structure and the data structure for the links from the countryregion node to the other nodes of the system and an agerange node data structure and the data structure for the links from the agerange node to the other nodes of the system, respectively. The gender node, the ethnicity node, the countryregion node and the agerange node are not shown in FIG. 7, but are similar to the input node in that it contains the information about input information and may generate one or more smart questions based on the input information.

For the data structures shown in FIGS. 8A-8K, each database table includes the one or more fields shown with an identifier which will now be described in more detail. Each table in the database has an ID field 190 (as shown in FIG. 8A) followed by a Name field. The ID field is named according to the name of the table suffixed by “id.” The ID field serves as the primary database key and is used for creating, maintaining and relating records. The “Name” field is used primary by developers as a human readable descriptor when creating and maintaining database records.

The other fields in the node tables may include:

pa=apriori probability

descr_public=public description

descr_prof=professional description

rel_citationid=pointer to relational table pointing to relevant literature citations

creatorid=user id of person creating entity

creationdate=timestamp when entity was created

notes=any information to help document the development of this entity

label_public=public name to be shown when the public views this entity

label_professional=professional name to be show when professionals view this entity

evidencelevel=indication of the level of evidence used in the creation of this entity:

1a—2+higher level studies

1b—1 higher level study

2a—2+ lower level studies

2b—1 lower level study

3a—multi-expert consensus w/data review

3b—single-expert opinion w/data review

3c—multi-expert consensus no data review

3d—single-expert opinion no data review

Standard National Library of Medicine Documentation Fields:

meshtreenumber, meshsynonyms, meshqualifierid, meshcasl, meshuniqueident all correspond to fields obtained from the NLM's MEsh system for documenting the node. MeSH is the Medical Subject Heading system developed by the National Library of Medicine at the National Library of Congress in Washington, D.C. It consists of sets of terms naming descriptors in a hierarchical structure that permits searching of research studies at various levels of specificity. There are 21,973 descriptors in MeSH. In addition to these headings, there are 132,123 headings called Supplementary Concept Records (formerly Supplementary Chemical Records) within a separate chemical thesaurus. There are also thousands of cross-references that assist in finding the most appropriate MeSH Headings and 102,346 other entry points. The MeSH is used by for indexing research articles from 4,600 of the world's leading biomedical journals for the MEDLINE® database, and is considered the premier international standard for such indexing efforts. The medical documentation fields in each node ensures that the nodes are consistent with current medical research and every node is matched with the appropriate term(s) in the MeSH medical information organizational system.

The fields common to the link tables (such as input_p_composite shown in FIG. 8A), in addition to the ID field described above, are:

name=name referred to by developers to describe the link

srcid=database id of the node this link connects from, the “finding”

destid=database id of the node this link connects to

tp=true positive fraction (probability that src is true when dest is true)

fp=false positive fraction (probability that src is true when dest is false)

pds=probability that dest is true when src is true

evidencelevel=indication of the level of evidence used in the creation of this entity:

1a—2+ higher level studies

1b—1 higher level study

2a—2+ lower level studies

2b—1 lower level study

3a—multi-expert consensus w/data review

3b—single-expert opinion w/data review

3c—multi-expert consensus no data review

3d—single-expert opinion no data review

descr_prof=description to display when viewed by professionals

descr_public=description to display when viewed by public

rel_citation=pointer to relevant literature citations

notes=developer documentation

Some tables contain additional fields, such as the node tables, to subcategorize for use in developing and reporting. These subcategories are described above.

FIG. 8L illustrates one or more content nodes of the expert system which contain information about a particular piece of content. As shown in FIG. 8L, the system may include a botanical medicine node 200 containing information about one or more botanicals, a toxin node 202 containing information about one or more toxins, a citation node 204 containing information about the literature/knowledge contained in the system, a foodspice node 206 containing information about various food spices, a disease node 208 containing information about different diseases and a nutrient node 210 containing information about one or more nutrients. For example, the botanical node may have a record which contains data about a particular botanical, its dosage, its side effects. etc which has been generated from the literature reviewed. Similarly, each of the other nodes may contain one or more records containing information about one or more diseases, toxins, foodspices and nutrients. These content nodes are utilized by the system for generating recommendations of foods, lifestyle changes, botanical medicines and nutrients to the user as well as providing information about a particular toxin or disease. The content nodes shown in FIG. 8L are different from the nodes shown in FIGS. 8A-8K in that these nodes contain content information used by the system wherein the other nodes receive one or more inputs and process those inputs to generate probability information.

The content tables shown in FIG. 8L, in addition to the ID field, name and the other common fields described above, may include various text fields used to describe each element. These include such fields as scientificname, familyname, commonnames, summary, historicaluse, typicaluses, typicaldosages, sideeffects, interactions, toxicology, contraindications, etc. These fields are reported to the user as appropriate in documenting recommendations, physiologic state or in an educational capacity.

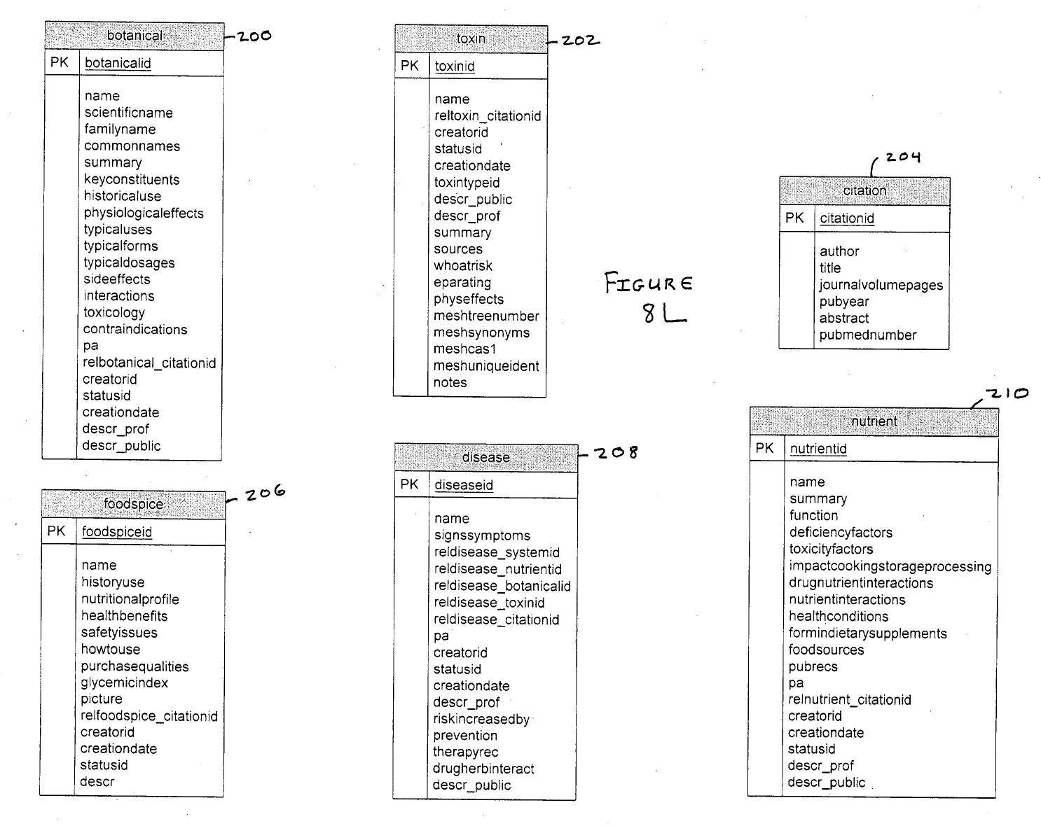

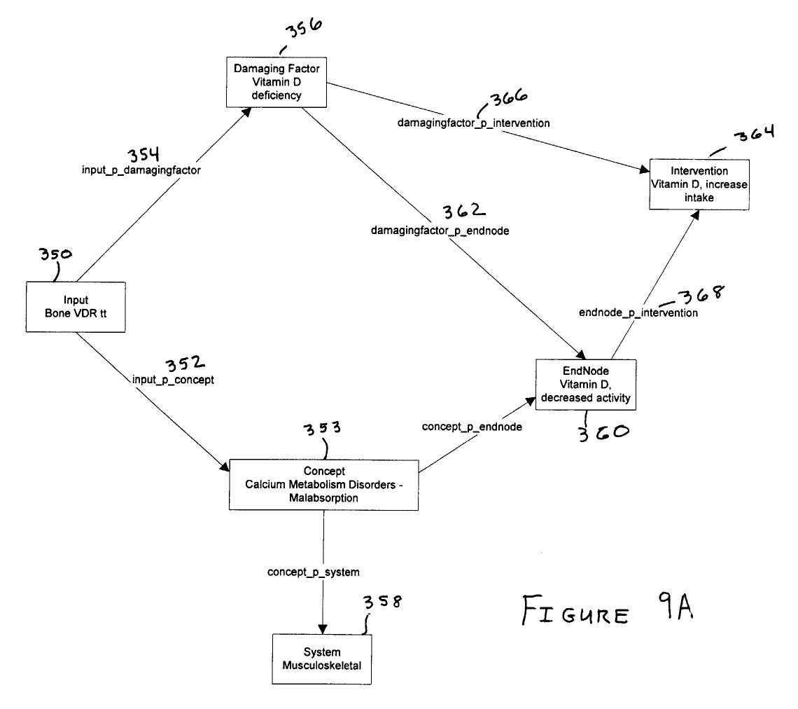

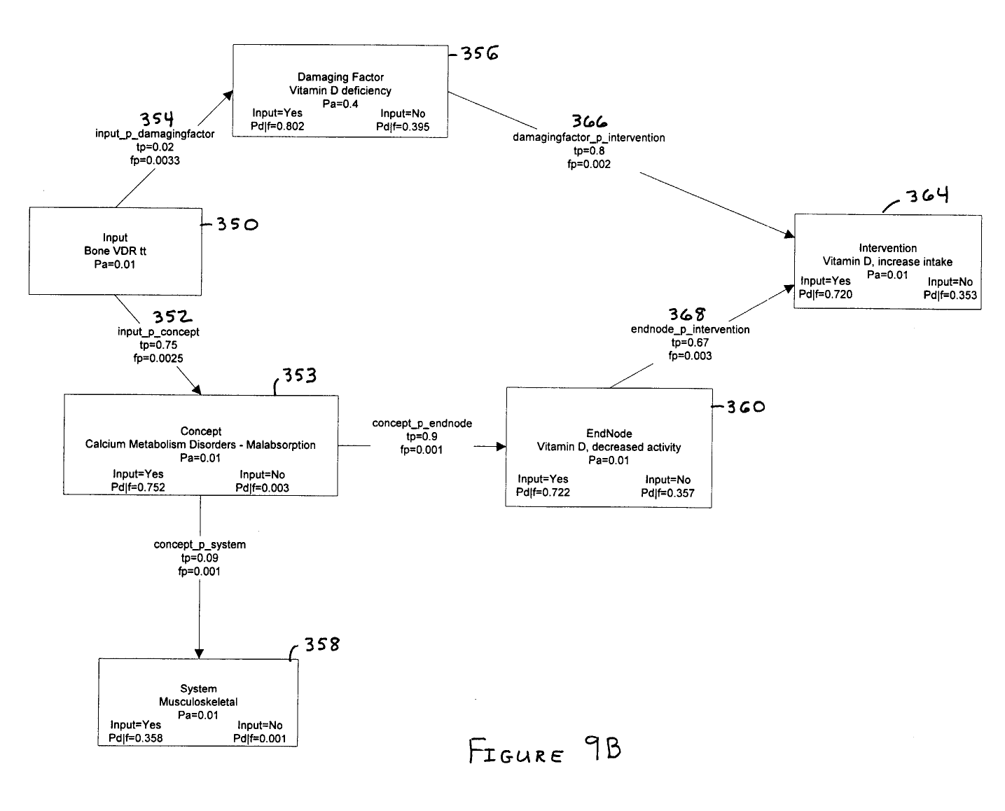

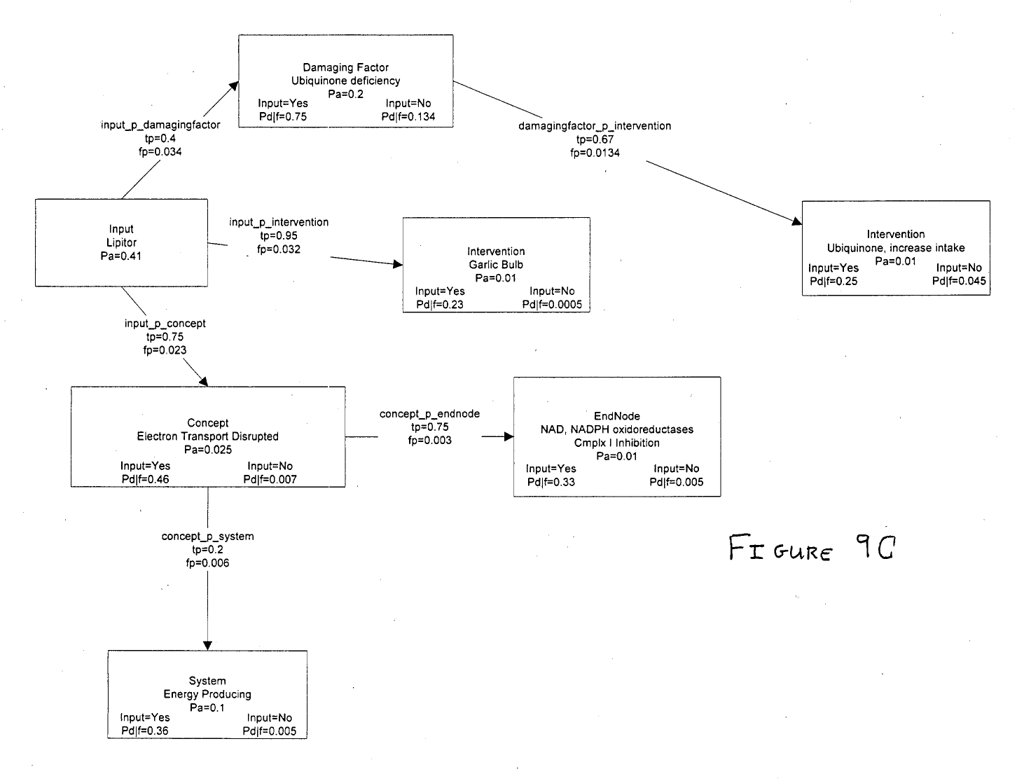

FIG. 9A is a diagram illustrating an example of the operation of the expert system in accordance with the invention. In particular, in this example, the diagram shows nodes and links representing a set of relationships affected by an input 350: Bone VDR-tt, vitamin D receptor variant tt genomic polymorphism. This input is linked to a concept node 353: Calcium Metabolism Disorders—Malabsorption (see input_p_concept link 352) and to a Damaging Factor node 356: Vitamin D deficiency (See input_p_damaging factor 354). The concept node 353 is linked to a Musculoskeletal System node 358 as well as an End Node 360: Vitamin D, Decreased Activity which also has a link 362 from the Damaging Factor node 356. An Intervention node 364: Vitamin D, Increase Intake has links 366, 368 from the Damaging Factor node 356 and the End Node 360. Conceptually, the intervention (increase Vitamin D intake) is presented to the user as a recommendation from the personalized health care system whenever there is a likelihood that it will address underlying problems (increased need for Vitamin D). Similarly, the system status (system Musculosketal in this example) is presented to the user to indicate the underlying physiological state. In this example, the input (Bone VDR-tt genomic polymorphism) can directly affect the concept causing possible changes to both the system and the end node. The input also affects the damaging factor which may also affect the endnode. This is important since there may be other links to the damaging factor that may not necessarily have links to the same concept (i.e., there are other indications of vitamin d deficiency than Bone VDR tt). The intervention is affected by the endnode as well as directly by the damaging factor.

FIG. 9B illustrates the example node system shown in FIG. 9A with the Bayesian probabilities in accordance with a preferred embodiment of the invention. The nodes and links are identical to those shown in FIG. 9A. However, in this diagram, the Bayesian probabilities used in the preferred embodiment of the invention are shown and described. In particular, each node has an apriori probability assigned to it (Pa) which is the probability of occurrence in the general population which are generated based on various health literature and knowledge. For example, the probability of a vitamin D deficiency (node 356) in the general population is 0.4 (40%). Each link (link input _p_damagingfactor 354 for example) has statistics (tp and fp) describing, probabilistically, how the two nodes connected by each link are related to each other where tp is the true positive fraction and fp is the true false fraction. The system then uses a Bayesian calculation to determine the posterior probability for each node based on the apriori probability and the link statistics using the Bayesian formula:

Pd|f=Pf*Pa*tp/(Pa*tp+(1−Pa)*fp)

where: Pf is the apriori probability of the “finding” or input node, tp and fp are the true and false positive fractions, Pa is the apriori probability and Pd|f is the posterior probability given the “finding” for the current node. In the case that the finding is actually an input node (Pf=1 for yes), we revise the formula to compute the probability given that the finding is false as:

Pd|f=Pa*(1−tp)/(Pa*(1−tp)+(1−Pa)*(1−fp))

Applying these calculations sequentially for each node and link in the system shown above, the posterior probabilities (Pd|f and Pd|t) obtained at each node for both cases (Yes and No) for the input are shown. In this manner, an input (Bone VDR tt in this example), generates a probability of a vitamin D deficiency of 0.802 which results in an Vitamin D increase intake intervention recommendation probability of 0.0720. Thus, for this example, the final conclusions presented to the user are:

1) Increasing Vitamin D intake has a 72% probability of helping if VDR tt is true, 35% if false.

2) The Probability of Musculoskeletal dysfunction of 36% if VDR tt is true, 0.1% if false.

The other probabilities shown in the example may be reported to the user depending on their level of interest in seeing the detail.

To better understand the invention, an example of the operation of the system when used for a person with a complex disease such as asthma now will be described. The following is a written narrative of what a user would experience as the user uses the system. An example of the graphical user interface provided to the user is shown and described below with references to FIGS. 10A-10Q. Once the user has entered some basic information about himself/herself, such as shown in FIG. 10B, the system may generate probabilities for the user in several areas including: 1) Health system dysfunction; 2) Deficiency of all nutrients; 3) Causes of dysfunction; and 4) Tentative recommendations. The user may then enter diet information, health problems, work place and type, symptoms and/or laboratory tests information into the system. The system then refines the above list and the probabilities using Bayesian or Boolean logic as determined by the nodes activated in the expert system. At each step in the process, the system also generates a list of potential “Smart questions” to ask of the user wherein the list is prioritized according the probable impact of the question on gathering further information about the user. For example, a question about a symptom of high blood pressure might be less prioritized than a question about a symptom of asthma. Based on the highest probabilities generated by the nodes and links of the expert system, the Smart questions are repeatedly asked of the user, so that the lists and probabilities noted above can be progressively refined and the best recommendations made to the user.

FIGS. 9C and 9D are further examples of the operation of the expert system. In particular, FIG. 9C illustrates an input node for Lipitor with two different interventions identified. FIG. 9D illustrates an input node for a peptic ulcer and two different interventions. Thus, as described above, the expert system has a plurality of input nodes (three are shown in FIGS. 9A, 9C and 9D) wherein each input node has a set of unique links to other nodes of the system as shown. Now, an example of that process will be provided in more detail.

A user may enter information about himself (50 year old white male living in West area of the country) at the initial screen and the system may generate the following list of nutrient deficiency probabilities: (in addition to the other areas noted above, but not shown here for clarity)

| | |
|---|---|
| 0.990 | omega-3 fatty acids |
| 0.711 | copper |
| 0.389 | zinc |
| 0.376 | vitamin a |
| 0.366 | vitamin e |
| 0.349 | dietary fiber |
| 0.324 | vitamin c |
| 0.302 | calcium |
| 0.279 | vitamin b6 |
| 0.253 | magnesium |

The user may then enter “Asthma” as a disease using the next user interface screen. As a result of that input, which is processed by the expert system, the system may generate the following new list of probabilities:

Health system dysfunction probability:

| | |
|---|---|
| 0.667 | Digestive |
| 0.667 | Inflammatory |
| 0.333 | Detoxification |

Probabilities for nutrient deficiencies (only top 10 listed)

| | |
|---|---|
| 0.990 | omega-3 fatty acids |
| 0.723 | magnesium |
| 0.711 | copper |
| 0.389 | zinc |
| 0.376 | vitamin a |
| 0.366 | vitamin e |
| 0.349 | dietary fiber |
| 0.324 | vitamin c |
| 0.302 | calcium |
| 0.279 | vitamin b6 |

Probabilities for toxin exposure reactions

| | |
|---|---|
| 0.933 | Sulfur dioxide |
| 0.444 | Aspirin (new) |
| 0.155 | Azo dye: tartrazine, sunset yellow, amaranth, new coccine (both |
| | red) |
| 0.055 | Sodium sulfite |
| 0.022 | Non-azo dye pale blue |
| 0.036 | Benzoate |

Probabilities for Nutritional Excesses:

Probabilities for Lifestyle Problems:

Probabilities for Food Intolerances:

Recommendations for:

Supplements:

omega-3 fatty acids

magnesium

copper

Foods to Avoid:

Botanical Medicines:

| | |
|---|---|
| 0.700 | Boswellia serrata |
| 0.400 | Aloe vera |
| 0.400 | Onions |

Lifestyle Recommendations:

Practitioner Recommendations: 4

Food Sources (Long List Prioritized According to how Well it Matches Nutrients Needed)

Recipes that Include These Foods

As shown in this example, the user entered “asthma” as a known disease. The system, due to the expert system, changed the probability of magnesium deficiency based on the “asthma” input. The system also added toxin exposure reactions based on the asthma input. In accordance with the invention, the expert system has a link between an “asthma” input node and a “magnesium deficiency” damaging factor node and a link between the “asthma” input node and a “toxin exposure reaction” node.

Once these probabilities are determined, the system may generate more smart questions. For example, the system may generate questions about diet to better determine nutrient deficiencies or questions about health systems. The system has identified a probability of digestive dysfunction and therefore generate a list of unique and personalized questions about signs and symptoms typical of hypochlorhydria (e.g., Do you experience: A sense of “fullness” after eating; weak, pealing nails; excessive gas after digestion; etc.?) The system may also generate a list of questions about diseases commonly associated with hypochlorhydria (e.g., asthma, inflammatory bowel disease, etc.) After receiving answers to the above Smart questions, the probabilities are further refined.

As another example, a person may have arteriosclerosis and the system may identify a potentially large number of physiological dysfunctions indicating dietary, nutrient and lifestyle needs. A careful review of the research literature yielded over 15 scientifically validated nutrients, all of which may be critically important for a person with arteriosclerosis. The same kind of critical nutrient needs have been shown for virtually every chronic disease prevalent in our society. The challenge, however, is to determine which of these nutrients is specifically needed by each biochemically-unique individual It is impossible for a practitioner to know all the biochemical pathways, recognize which symptoms and diseases are associated with dysfunction of which biochemical pathways, and then to make mathematically-accurate inferences and decisions based upon the present invention. By methodically and exhaustively reviewing the medical research literature, we build the system logic link by logic link. Equally important is recognizing which nutrients may be inappropriate, as well as which lifestyle, environmental toxin exposure and genetic tendencies may be playing a role in a person's health problem. Most available dietary supplements simply supply several of the most commonly needed nutrients to provide “structure and function” support. Unfortunately, this “shotgun” approach is rarely able to safely and economically provide the dosage levels actually needed to significantly improve the condition and is very likely to not even contain the specific nutrients that are most needed. On the other hand, trying to ask a user every question necessary to determine the presence of a possible deficiency would be prohibitively burdensome.

The solution is to use artificial intelligence to guide the determination of the individual's most important physiological dysfunctions and the interventions most likely to restore normal function. This is accomplished by using rigorous probabilistic reasoning based on sound physiological understanding. The system asks a limited number of leading questions, the answers to which provide probabilistic ranking to progressively more relevant and differentiating questions. The only questions that are asked are those from nodes that have elevated probabilities. The probability of the nodes being true is based on the information the user has provided. Each record in the database is a node or probabilistic link for the expert system. By answering “smart questions,” the user can be guided through a targeted series of questions to create a map of his or her unique metabolic and functional needs, ranked by probability. This questioning methodology is “smart” because it is determined by the user's responses, and questions are ranked according to the magnitude of impact the answer could generate. For example, in arteriosclerosis, the probability of a B6 deficiency is 40%. But which person with arteriosclerosis needs supplemental B6? The smart system asks key questions to determine if the person's homocysteine is elevated, such as inquiring about the presence of other diseases associated with an elevated level of homocysteine and other indications of a B6 deficiency or improved by B6 supplementation, as well as the common signs and symptoms of B6 deficiency. Upon completion of this process, nutrients, botanicals, lifestyle recommendations, etc. are rank-ordered according to the probability of their efficacy in matching the individual's unique needs.

Progressively working through a list of perhaps a hundred questions (out of a database of several thousand) yields advice individualized at a level never before available. Equally important, this highly targeted advice will be cost-effective and the most probable to actually facilitate an improvement in health. By providing the health advice most likely to promote wellness, and not wasting time and resources on approaches unlikely to be helpful, the user is more likely to implement the recommendations, experience benefits and not waste funds. In addition, by mapping the user's unique physiology we are also more able to accurately predict, and thus avoid, potential adverse drug/herb/nutrient interactions.

FIGS. 10A-10Q are diagrams illustrating an example of the preferred embodiment of the user interface of the health advice system in accordance with the invention. In particular, FIG. 10A illustrates an initial user interface screen 400. As shown, the screen may include one or more tabs 402 in a first input/output pane 404 which provides information to the user and permits the user to interact with the system. The tabs permit the user to select and view a particular screen, such as the welcome screen shown in FIG. 10A, an about me screen shown in FIG. 10B, a conditions screen shown in FIG. 10C, a medications screen shown in FIG. 10D, a tests screen shown in FIG. 10E, a diet screen shown in FIG. 10F, a questions screen shown in FIG. 10G, a causes screen shown in FIG. 10H and a recommendations screen shown in FIG. 10I. The user interface screen 400 may further include a graphics pane 406 that may include one or more tabs 408. The tabs 408 permit the user to select and view a particular screen, such as the system screen (shown in FIGS. 10A-10I) which depicts a user's body 409 wherein particular portions/systems of the body picture are colored to indicate the level of dysfunction of that particular part of the body. As the user progresses through the process, the body map is continually updated. The tabs 408 may also permit the user to display a function screen as shown in FIG. 100, a environment screen as shown in FIG. 10P and a library screen as shown in FIG. 10Q.

FIG. 10B illustrates an “About Me” screen 410. As will be apparent, this screen and the other screens shown in FIGS. 10C-10I may include a progress indicator 412 which indicates the completeness of the information that the system had obtained from the user. It is noted that the progress indicator indicates a higher level of completion from FIGS. 10B-10I. As shown in FIG. 10B, the system enters various information including personal information and environmental information. FIG. 10C illustrates a conditions screen 414 in which the system asks the user about particular diseases which the user might have since these diseases may affect the resulting recommendations of the system as well as change the body map coloration based on the user input. FIG. 10D is a medication screen 416 in which the user enters information about the medications being taken by the user since these medications may have side effects on particular body systems which should be taken into account when providing recommendations to the user. FIG. 10E is a tests screen 418 in which the user enters any test information, including lab test information and genomic profile information, that the user is aware of at the time. As stated above, the progress indicator 412 now indicates 44% progress indicating that the system has obtained just under half of the information it might be able to obtain to provide recommendations.

FIG. 10F illustrates a diet screen 420 in which the user enters diet information into the system. Once the user has entered the various information into the screen shown in FIGS. 10B-10F, the system may present a questions screen 422 to the user as shown in FIG. 10G. The questions screen may present one or more smart questions to the user. The smart questions are selected by the system (the expert system) from a database of thousands of questions wherein the selected questions are those which are most likely to provide the system with more information about a particular system dysfunction which the system has detected for the user based on the prior information provided to the system. Thus, the user does not answer questions which are either unlikely to lead to useful information or do not pertain to the particular user. For example, a user of the system who does not have any indication of a digestive problem would not be presented with all of the questions shown in FIG. 10G since those questions are very directed towards digestive problems.

FIG. 10H illustrates a causes screen 424 wherein the user is presented with the causes (and the probabilities of those causes) of the system dysfunctions which have been determined by the expert system based on the information entered by the user in the screens shown in FIG. 10B-10G. The body map 409 illustrates the dysfunctional body systems. As shown in FIG. 10H, the causes may include nutrient deficiencies, toxin exposure and nutrient excess. The system may also generate lists of other causes as described above but not shown in FIG. 10H. For each cause, such as folic acid deficiency, the system lists the probability (98.2% for folic acid deficiency) that the particular causes contributes to one or more of the body system dysfunctions shown on the body map 409 and identified by the system. The probabilities shown are generated by the expert system based on the information provided by the user to the system based on the knowledge base contained in the system.

FIG. 10I illustrates a recommendation screen 426 in which the system presents the user with recommendations of how to repair the system dysfunctions identified by the system based on the information provided by the user. As shown in FIG. 10I, the recommendations may include nutrient supplements (with a probability of helping to resolve the system dysfunction), diet, lifestyle, botanical and acupuncture recommendations. The system may also provide other recommendations not shown in FIG. 10I. The screen 426 may also list interactions as shown which indicate the probability of drug interactions/warnings of which the user should be aware. In the example shown in FIG. 10I a depression/kava interaction is listed indicating that people with depression should not use kava. The screen 426 may further include a finalize recommendations button 428. When the user depresses that button, the system display a screen 430 shown in FIG. 10J with finalized personal recommendations. In the finalized recommendations, each recommendation (such as folic acid, increase intake) has a probability as before, but also has one or more reasons 432 for the recommendation so that the user is able to review any of the reasoning behind the recommendation by the system. For example, FIG. 10K illustrates a concept screen 434 which lists information about a reason for a recommendation (the brain chemicals are out of balance” in this example.

FIG. 10L illustrates a screen 436 containing information about a particular supplement (folic acid in this example) including forms of folic acid, dosage information, food source information and the like. FIG. 10M illustrates a screen 438 which contains information about a particular system dysfunction (the regulatory system in this example) which may be accessed by the user by selecting a system tab from the screen shown in FIG. 10A on the right hand pane (the display pane 406). In the example shown in FIG. 10M, the user has selected the regulatory system dysfunction screen. FIG. 10N illustrates a screen 440 which may be generated when the user selects the “Chemical Imbalance Related to B Vitamins” from the screen shown in FIG. 10M. In accordance with the invention, when the user selects information about a particular system dysfunction, the system provides the information with additional links (shown underlined in FIG. 10M) which may be selected by the user to review further information about another topic. Thus, in addition to providing the user with recommendations of how to repair system dysfunction, the system also provides information to the user which supports the recommendations and which is helpful to the user to understand the system dysfunctions.

FIG. 10O illustrate a screen 442 wherein the user has selected the function tab in the display pane 406 as shown. As a result, the system displays a function display 444 illustrating the functioning of the systems which determine the level of health of the user (detoxification, energy, inflammatory, metabolic, mind/body, regenerative and signaling are shown in this example.) Using this screen, the user may access various information about these functions. FIG. 10P is a screen 446 wherein the user has selected the environment tab in the display pane 406 as shown. As a result, the system displays an environment display 448 illustrating the functioning of the systems which determine the level of health of the user (diet, lifestyle, toxic exposure and psychosocial are shown in this example.) Using this screen, the user may access various information about these functions. FIG. 10Q is a screen 449 wherein the user has selected the library tab in the display pane 406 as shown. As a result, the system displays a library display 450 illustrating the additional information that may be accessed by the user. In the example shown in FIG. 10Q, the library may contain explanations about particular topics, references (literature) about particular topics, educational about particular topics and links to additional information. Thus, in addition to the determination of system dysfunction as described above, the system may also provide the user with additional information about various health care related topics that may be of interest to the user.

While the foregoing has been with reference to a particular embodiment of the invention, it will be appreciated by those skilled in the art that changes in this embodiment may be made without departing from the principles and spirit of the invention, the scope of which is defined by the appended claims.

1. A computer implemented system for generating personalized health care recommendations to correct physiological dysfunction, the system comprising:
a first computer having a processor that executes a health care expert system and a database for storing one or more pieces of health care information used by the expert system to generate health care recommendations;
a second computer connected to the first computer by a computer network, the second computer further comprising a processor that executes a software application for receiving a user interface from the first computer over the computer network; and
wherein the second computer communicates user related health information to the first computer using the user interface and the expert system generates one or more health care recommendations for the user based on the user related health information.

2. The system of claim 1, wherein the expert system generates one or more different types of health care recommendations and a probability of efficacy for each health care recommendation and wherein all of the health care recommendations are ranked, independent of intervention type, according to the probability of efficacy.

3. The system of claim 1, wherein the expert system further comprises one or more nodes and one or more links between the nodes wherein the nodes contain a piece of evidence and wherein each link from a first node to a second node indicates the probability of the piece of evidence in the first node indicating the piece of evidence in the second node.

4. The system of claim 3, wherein the one or more nodes further comprise one or more input nodes, one or more damaging factor nodes, one or more concept nodes, one or more endnode nodes and one or more intervention nodes; and
wherein each input node comprises a piece of health information input into the expert system, each damaging factor node comprises a cause of dysfunction, each concept node comprises an abstract dysfunction of a user, each endnode node comprises a dysfunction of a user at a physiological level and each intervention node comprises an intervention to repair a dysfunction of the user.

5. The system of claim 4, wherein the one or more nodes further comprises one or more composite nodes wherein each composite node comprises an action to be taken based on two or more pieces of health information inputs.

6. The system of claim 3, wherein the probability associated with each link further comprises a true positive probability and a false positive probability.

7. The system of claim 6, wherein each node further comprises an apriori probability of being true.

8. The system of claim 7, wherein each node generates a probability of the node being true wherein the probability is based on the true positive and false positive probabilities of the link to the node and the apriori probability associated with the node.

9. The system of claim 3, wherein each node generates a probability of the dysfunction contained in the node wherein the probability is Boolean.

10. The system of claim 3, wherein the nodes and links of the expert system are stored in the database as one or more database tables.

11. The system of claim 10, wherein the database further comprises one or more tables that store health care related literature.

12. The system of claim 1, wherein the recommendations further comprises a health status of the user, a dosage recommendation and a literature recommendation.

13. The system of claim 3, wherein each node generates one or more smart questions based on the information provided from the user, the smart questions generated in order to gather more information about the user.

14. The system of claim 13, wherein the expert system prioritizes the smart questions generated by the nodes of the expert system based on the probability that the question will lead to further information about the user.

15. The system of claim 8, wherein each node probability further comprises
Pd|f=Pf*Pa*tp/(Pa*tp+(1−Pa)*fp)
where Pf is the apriori probability of the “finding” or input node, tp and fp are the true and false positive fractions, Pa is the apriori probability and Pd|f is the posterior probability given the “finding” for the current node.

16. The system of claim 4, wherein the nodes further comprise an interactions node which identifies interactions between recommendations and drug therapy wherein the interactions node identifies drug therapy side-effects and identifies nutrients to counteract the drug therapy side-effects.

17. A computer implemented method for generating personalized health care recommendations to correct physiological dysfunction using a health care expert system and a database for storing one or more pieces of health care information used by the expert system to generate personalized health care recommendations, the method comprising:
receiving a user interface;
communicating user related health information to the computer using the user interface; and
generating health care recommendations using the health care expert system for the user based on the user related health information.

18. The method of claim 17, wherein the expert system generates one or more different types of health care recommendations and a probability of efficacy for each health care recommendation and wherein all of the health care recommendations are ranked, independent of intervention type, according to the probability of efficacy.

19. The method of claim 17, wherein the expert system further comprises one or more nodes and one or more links between the nodes wherein the nodes contain a piece of evidence and wherein each link from a first node to a second node indicates the probability of the piece of evidence in the first node indicating the piece of evidence in the second node.

20. The method of claim 19, wherein the one or more nodes further comprise one or more input nodes, one or more damaging factor nodes, one or more concept nodes, one or more endnode nodes and one or more intervention nodes; and
wherein each input node comprises a piece of health information input into the expert system, each damaging factor node comprises a cause of dysfunction, each concept node comprises an abstract dysfunction of a user, each endnode node comprises a dysfunction of a user at a physiological level and each intervention node comprises an intervention to repair a dysfunction of the user.

21. The method of claim 20, wherein the one or more nodes further comprises one or more composite nodes wherein each composite node comprises an action to be taken based on two or more pieces of health information inputs.

22. The method of claim 19, wherein the probability associated with each link further comprises a true positive probability and a false positive probability.

23. The method of claim 22, wherein each node further comprises an apriori probability of a node being true.

24. The method of claim 23, wherein each node generates a probability of the node being true wherein the probability is based on the true positive and false positive probabilities of the link to the node and the apriori probability associated with the node.

25. The method of claim 19, wherein each node generates a probability of the node wherein the probability is Boolean.

26. The method of claim 19, wherein the nodes and links of the expert system are stored in the database as one or more database tables.

27. The method of claim 26, wherein the database further comprises one or more tables that store health care related literature.

28. The method of claim 17, wherein the recommendations further comprises a health status of the user, a dosage recommendation and a literature recommendation.

29. The method of claim 19, wherein each node generates one or more smart questions based on the information provided from the user, the smart questions generated in order to gather more information about the user.

30. The method of claim 29, wherein the expert system prioritizes the smart questions generated by the nodes of the expert system based on the probability that the question will lead to further information about the user.

31. The method of claim 24, wherein each node probability further comprises
Pd|f=Pf*Pa*tp/(Pa*tp+(1−Pa)*fp)
where Pf is the apriori probability of the “finding” or input node, tp and fp are the true and false positive fractions, Pa is the apriori probability and Pd|f is the posterior probability given the “finding” for the current node.

32. The method of claim 20, wherein the nodes further comprise an interactions node which identifies interactions between recommendations wherein the interactions node identifies drug therapy side-effects and identifies nutrients to counteract the drug therapy side-effects.

33. A computer implemented system for generating personalized health care recommendations to correct physiological dysfunction, the system contained in one or more instructions and being executed by a processor of a computer system, the system comprising:
a health care expert system;
a database for storing one or more pieces of health care information used by the expert system to generate health care recommendations; and
one or more instructions that receive user related health information and one or more instructions that generate health care recommendations for the user based on the user related health information.

34. The system of claim 33, wherein the expert system generates one or more different types of health care recommendations and a probability of efficacy for each health care recommendation and wherein all of the health care recommendations are ranked, independent of intervention type, according to the probability of efficacy.

35. The system of claim 33, wherein the expert system further comprises one or more nodes and one or more links between the nodes wherein the nodes contain a piece of evidence and wherein each link from a first node to a second node indicates the probability of the piece of evidence in the first node indicating the piece of evidence in the second node.

36. The system of claim 35, wherein the one or more nodes further comprise one or more input nodes, one or more damaging factor nodes, one or more concept nodes, one or more endnode nodes and one or more intervention nodes; and
wherein each input node comprises a piece of health information input into the expert system, each damaging factor node comprises a cause of dysfunction, each concept node comprises an abstract dysfunction of a user, each endnode node comprises a dysfunction of a user at a physiological level and each intervention node comprises an intervention to repair a dysfunction of the user.

37. The system of claim 36, wherein the one or more nodes further comprises one or more composite nodes wherein each composite node comprises an action to be taken based on two or more pieces of health information inputs.

38. The system of claim 35, wherein the probability associated with each link further comprises a true positive probability and a false positive probability.

39. The system of claim 38, wherein each node further comprises an apriori probability of being true.

40. The system of claim 39, wherein each node generates a probability of the node being true wherein the probability is based on the true positive and false positive probabilities of the link to the node and the apriori probability associated with the node.

41. The system of claim 35, wherein each node generates a probability of the node wherein the probability is Boolean.

42. The system of claim 35, wherein the nodes and links of the expert system are stored in the database as one or more database tables.

43. The system of claim 42, wherein the database further comprises one or more tables that store health care related literature.

44. The system of claim 33, wherein the recommendations further comprises a health status of the user, a dosage recommendation and a literature recommendation.

45. The system of claim 35, wherein each node generates one or more smart questions based on the information provided from the user, the smart questions generated in order to gather more information about the user.

46. The system of claim 45, wherein the expert system prioritizes the smart questions generated by the nodes of the expert system based on the probability that the question will lead to further information about the user.

47. The system of claim 40, wherein each node probability further comprises
Pd|f=Pf*Pa*tp/(Pa*tp+(1−Pa)*fp)
where Pf is the apriori probability of the “finding” or input node, tp and fp are the true and false positive fractions, Pa is the apriori probability and Pd|f is the posterior probability given the “finding” for the current node.

48. The system of claim 36, wherein the nodes further comprise an interactions node which identifies interactions between recommendations wherein the interactions node identifies drug therapy side-effects and identifies nutrients to counteract the drug therapy side-effects.

49. A computer-implemented personalized health care expert system, comprising:
one or more input nodes wherein each input node comprises a piece of health information input into the expert system;
one or more damaging factor nodes wherein each damaging factor node comprises a cause of dysfunction;
one or more concept nodes wherein each concept node comprises an abstract dysfunction of a user;
one or more endnode nodes wherein each endnode node comprises a dysfunction of a user at a physiological level;
one or more intervention nodes wherein each intervention node comprises an intervention to repair a dysfunction of the user; and
one or more links between the nodes of the expert system, each link from a first node to a second node indicates the probability of the piece of evidence in the first node indicating the piece of evidence in the second node.

50. The system of claim 49, wherein the expert system generates one or more different types of interventions and a probability of efficacy for each health care intervention and wherein all of the health care interventions are ranked according to the probability of efficacy.

51. The system of claim 49, wherein the one or more nodes further comprises one or more composite nodes wherein each composite node comprises an action to be taken based on two or more pieces of health information inputs.

52. The system of claim 49, wherein the probability associated with each link further comprises a true positive probability and a false positive probability.

53. The system of claim 52, wherein each node further comprises an apriori probability of being true.

54. The system of claim 53, wherein each node generates a probability of the node being true wherein the probability is based on the true positive and false positive probabilities of the link to the node and the apriori probability associated with the node.

55. The system of claim 49, wherein each node generates a probability of the dysfunction contained in the node wherein the probability is Boolean.

56. The system of claim 49, wherein the nodes and links of the expert system are stored in the database as one or more database tables.

57. The system of claim 56, wherein the database further comprises one or more tables that store health care related literature.

58. The system of claim 49, wherein each node generates one or more smart questions based on the information provided from the user, the smart questions generated in order to gather more information about the user.

59. The system of claim 58, wherein the expert system prioritizes the smart questions generated by the nodes of the expert system based on the probability that the question will lead to further information about the user.

60. The system of claim 54, wherein each node probability further comprises
Pd|f=Pf*Pa*tp/(Pa*tp+(1−Pa)*fp)
where Pf is the apriori probability of the “finding” or input node, tp and fp are the true and false positive fractions, Pa is the apriori probability and Pd|f is the posterior probability given the “finding” for the current node.

61. The system of claim 49, wherein the nodes further comprise an interactions node which identifies interactions between recommendations wherein the interactions node identifies drug therapy side-effects and identifies nutrients to counteract the drug therapy side-effects.

62. A computer-implemented personalized health care expert system, comprising:
one or more input nodes wherein each input node comprises a piece of health information input into the expert system;
one or more damaging factor nodes wherein each damaging factor node comprises a cause of dysfunction;
one or more concept nodes wherein each concept node comprises an abstract dysfunction of a user;
one or more endnode nodes wherein each endnode node comprises a dysfunction of a user at a physiological level;
one or more intervention nodes wherein each intervention node comprises an intervention to repair a dysfunction of the user;
one or more links between the nodes of the expert system, each link from a first node to a second node indicates the probability of the piece of evidence in the first node indicating the piece of evidence in the second node; and
wherein the nodes and links of the expert system are stored in a relational database with each node and each link being stored in a table of the relational database.
